(19) United States
(12) Patent Application Publication
(10) Pub. No.: US 2013/0003842 A1
(43) Pub. Date: Jan. 3, 2013

(54) APPARATUS AND METHOD FOR IMAGE PROCESSING, AND PROGRAM

(75) Inventor: Kenji Kondo, Tokyo (JP)

(73) Assignee: SONY CORPORATION, Tokyo (JP)

(21) Appl. No.: 13/520,384

(22) PCT Filed: Jan. 6, 2011
(86) PCT No.: PCT/JP2011/050101

§ 371 Date: Jul. 3, 2012

(30) Foreign Application Priority Data
Jan. 18, 2010 (JP) 2010-007806

(51) Int. Cl. H04N 7/32

(52) U.S. Cl. 375/240.14; 375/E07.104; 375/E07.243

(57) ABSTRACT

The present invention relates to apparatuses and methods for image processing by which improvement in prediction accuracy for B pictures, especially in the vicinity of edges of screens, is achievable, and programs therefor. A motion compensator is adapted to generate a prediction image by weighted prediction according to H.264/AVC standard by using the on-screen portion of a reference region in an L0 reference picture and to generate a prediction image by not using the off-screen portion of the reference region in the L0 reference picture and by restrictively using a reference region in an L1 reference picture. Specifically, in the L0 reference picture, as depicted in the reference region for L0 reference, the reference region is the dashed square on the outer side, but in actuality, the region within the dashed square on the inner side is restrictively used for prediction. The present invention is applicable to an image coding apparatus for performing encoding based on, for example, H.264/AVC standard.

### TECHNICAL FIELD

The present invention relates to apparatuses and methods for image processing, and programs therefor, and more particularly, to apparatuses and methods for image processing allowing for improved prediction accuracy for B pictures, especially in the vicinity of edges of screens, and programs therefor.

### BACKGROUND ART

Standards for compression of image information include H.264 and MPEG-4 Part 10 (Advanced Video Coding, hereinafter referred to as “H.264/AVC.”).

According to H.264/AVC, inter prediction is performed with focus on the correlation between frames or fields. In the motion-compensation processing to be performed in this inter prediction, a prediction image (hereinafter referred to as an “inter prediction image”) is generated through inter prediction by using a portion of a region in a referenceable image that has already been stored.

For example, as depicted in FIG. 1, in the case where reference frames are five frames of referenceable images that have already been stored, a portion of the inter prediction image of a frame (an original frame) to be inter-predicted is constructed with reference to a portion of the image of any one of the five reference frames (hereinafter referred to as a “reference image.”) The position of the portion of the reference image to be the portion of the inter prediction image is decided by a motion vector detected based on the image of the reference frame and the original frame.

More specifically, as depicted in FIG. 2, when a face 11 in a reference frame is moved in the lower-right direction in the original frame and about one third of the lower face is concealed, a motion vector indicating an upper-left direction, which is reverse to the lower-right direction, is detected. Then, an unconcealed portion 12 of the face 11 in the original frame is constructed with reference to a portion 13 of the face 11 in the reference frame at the position where the portion 12 is moved according to the motion indicted by the motion vector.

Further, according to H.264/AVC, as depicted in FIG. 3, motion compensation is available by 16×16 pixels to 4×4 pixels in block size. This enables more accurate motion compensation, since, in the case where the motion limit is present in a macroblock (for example, of 16×16 pixels,) the block size is dividable into smaller sizes according to the limit.

Moreover, currently under consideration according to H.264/AVC is improvement in resolution of motion vectors to fractional precision such as half or quarter precision in the motion compensation processing.

In such motion compensation processing at fractional precision, pixels referred to as “Sub pels” are set at virtual fractional positions between adjacent pixels, and processing to generate the Sub pels (hereinafter referred to as “interpolation”) is additionally performed. More specifically, in the motion compensation at fractional precision, the minimum resolution of motion vectors is in the unit of pixels at fractional positions, and thus interpolation is performed to generate pixels at the fractional positions.

FIG. 4 depicts pixels of an image of which the number of pixels is increased by four times in the vertical and lateral directions by interpolation. In FIG. 4, the white squares indicate pixels at integer positions (Integer pels (Int. pels)), and the hatched squares indicate pixels at fractional positions (Sub pels). The alphabets in the squares indicate the pixel values of the pixels represented by the squares.

The pixel values b, h, j, a, d, f, and r of the pixels at the fractional positions to be generated by interpolation are represented by the following equations (1):

b=(E−5F+20G+20H−5I+J)/32

h=(A−5C+20G+20M−5R+T)/32

j=(aa−5bb+20b+20s−5gg+hh)/32

a=(G+b)/2

d=(G+h)/2

f=(b+j)/2

r=(m+s)/2 (1)

The pixel values aa, bb, s, gg, and hh are obtainable in a similar manner to the pixel value b, the pixel values cc, dd, m, ee, and ff are obtainable in a similar manner to the pixel value h, the pixel value c is obtainable in a similar manner to the pixel value a, the pixel values f, n, and q are obtainable in a similar manner to the pixel value d, and the pixel values e, p, and g are obtainable in a similar manner to the pixel value r, respectively.

The above equations (1) are equations adopted in interpolation according to, for example, H.264/AVC, and a different equation is used for a different standard. The purpose of the equations is however the same. These equations are implementable by means of a Finite-duration Impulse Response (FIR) filter with taps of an even number. For example, according to H.264/AVC, interpolation filters having 6 taps are used.

Further, according to H.264/AVC, in the case where the region to be referenced for a motion vector is outside the edge of the screen (the picture frame), as depicted in FIG. 5, the pixel values on the edge of the screen are duplicated.

In the reference picture depicted in the example of FIG. 5, the chain line indicates the edge of the screen (the picture frame), and the region between the chain line and the solid line on the outer side indicates a region that is extended by duplicating the pixels at the edge of the screen. In other words, the reference picture is extended by duplication at the edge of the screen.

It is to be noted here that, according to H.264/AVC, especially for B pictures, as depicted in FIG. 6, bidirectional prediction is adoptable. In FIG. 6, pictures are shown in a display order, and encoded reference pictures are arrayed ahead or behind the picture to be encoded in the display order. In the case where the picture to be encoded is a B picture, for example, as depicted with respect to the target prediction block in the picture to be encoded, two blocks in the front and back (bidirectional) reference pictures are referenced, so as to have a motion vector for forward L0 prediction and a motion vector for backward L1 prediction.

More specifically, display time is basically earlier than the target prediction block for L0, and display time is basically later than the target prediction block for L1. The reference pictures thus distinguished are providable for separate use according to coding modes. As depicted in FIG. 7, the coding modes have five kinds, i.e., intra-screen coding (intra prediction), L0 prediction, L1 prediction, bi-predictive prediction, and direct mode.

FIG. 7 depicts the relationship between the coding mode and the reference picture and the motion vector. It is to be noted that, in FIG. 7, the reference picture column shows whether or not reference pictures are used in the coding modes, and the motion vector column shows whether or not the coding modes involve motion vector information.

Intra-screen coding mode is a mode for performing prediction within (i.e., “intra”) screens, which is a coding mode that does not use L0 reference pictures and L1 reference pictures, and that does not involve motion vectors for L0 prediction and motion vectors for L1 prediction. L0 prediction mode is such that L0 reference pictures are restrictively used to perform prediction, which is a coding mode that involves vector information for L0 prediction. In L1 prediction mode, L1 reference pictures are restrictively used to perform prediction, which is a coding mode that involves motion vector information for L1 prediction.

In bi-predictive prediction mode, L0 and L1 reference pictures are used to perform prediction, which is a coding mode that involves motion vector information for L0 and L1 predictions. In direct mode, L0 and L1 reference pictures are used to perform prediction, but this coding mode does not involve motion vector information. In other words, direct mode is a coding mode that does not involve motion vector information, but in this coding mode, motion vector information in the current target prediction block is predicted and used based on the motion vector information of encoded blocks in reference pictures. It should be noted that either L0 or L1 reference picture is used in direct mode in some cases.

As described above, in bi-predictive prediction mode and in direct mode, both L0 and L1 reference pictures are used in some cases. In the case of two reference pictures, weighted prediction as represented by the following equation (2) provides prediction signals in bi-predictive prediction mode or in direct mode.

Y_{Bi-Pred}=W₀Y₀+W₁Y₁+D (2)

where Y_{Bi-Pred} is the weighted interpolation signal with offset in bi-predictive prediction mode or in direct mode, W₀ and W₁ are the weighting factors for L0 and L1, respectively, and Y₀ and Y₁ are the motion-compensating prediction signals for L0 and L1. The W₀, W, and D for use may be explicitly contained in bitstream information or may be obtained implicitly by calculation at the decoding side.

If degradation due to encoding of reference pictures is irrelevant to correlation between two reference pictures for L0 and L1, the weighted prediction allows for suppression of degradation due to encoding. As a result, residual signals, which are difference between prediction signals and input signals, are reduced, achieving cut in bit amount of the residual signals and hence improvement in coding efficiency.

It is to be noted that regarding direct mode, it is proposed in Non-patent Document 1 that, in the case where the region to be referenced includes an off-screen area, the reference picture thereof is not used and the other of the reference pictures is used.

According to H.264/AVC standard, the macroblock size is 16×16 pixels. It is not optimal however to have a macroblock size of 16×16 pixels for large picture frames such as UHN (Ultra High Definition; 4000×2000 pixels,) which can be an object of next-generation coding standards.

Then, for example, Non-patent Document 2 proposes the macroblock size be extended to a size such as 32×32 pixels.

### CITATION LIST

### Non-Patent Document

Non-Patent Document 1: Yusuke ITANI, Yuichi IDEHARA, Shun-ichi SEKIGUCHI, Yoshihisa YAMADA (Mitsubishi Electric Corporation,) “A Study on Improvement of Direct Mode for Video Coding,” IEICE Symposium 24th Video Coding material, pp. 3-20, Odaira, Izu, Shizuoka, Oct. 7, 8, 9, 2009
Non-Patent Document 1: “Video Coding Using Extended Block Sizes,” VCEG-AD09, ITU-Telecommunications Standardization Sector STUDY GROUP Question 16—Contribution 123, January 2009

### SUMMARY OF THE INVENTION

### Problems to be Solved by the Invention

As described above, in the case of using direct mode or bi-predictive prediction, reference regions in an L0 reference picture and an L1 reference picture are used. Herein, a situation may occur in which either the reference region for L0 reference or the reference region for L1 reference is off-screen.

The example depicted in FIG. 8 shows an L0 reference picture, a picture to be encoded, and an L1 reference picture from the left in the order of time course. In the pictures, the chain lines indicate the edge of the screen, and the regions between the solid lines and the chain lines indicate the region extended by duplication at the edge of the screen as described earlier in connection with FIG. 5.

Further, the regions enclosed with the dashed lines in the pictures indicate a reference region for L0 reference in the L0 reference picture, a motion-compensating region in the picture to be encoded, and a reference region for L1 reference in the L1 reference picture. The reference region for L0 reference and the reference region for L1 reference are extracted in the lower part of FIG. 8.

FIG. 8 depicts an example in which the hatched rhomboid object P in the picture to be encoded is moving from the upper left toward the lower right, and a portion of the object P transcends the edge of the screen to the outside in the L0 reference picture.

As described earlier with reference to FIG. 5, according to H.264/AVC standard, it is defined that the pixel values at the edge of the screen be duplicated for use when a reference region is off-screen. As a result, in the reference region in the L0 reference picture, the pixel values at the edge of the screen are duplicated, such that the shape is no longer a rhombus.

Consider a case of generating a prediction image by weighted prediction with reference to the L0 and L1 reference regions. When the off-screen pixel values are different from the actual ones as in the reference region for L0 reference of FIG. 8, it is anticipated that a large difference occurs between the prediction image and source signals. The large difference obviously leads to increase in bit amount of residual signals, which may invite lowering of coding efficiency.

On the other hand, also under consideration is a method of reducing the block size for motion compensation. Subdividing the block size however invites increase in header information of the macroblock, leading to increase of overhead. In the case of a large quantization parameter QR, or in the case of a low bit rate, the header information for the macroblock occupies a proportionally large processing quantity as overhead. Thus, the method of subdividing the block size may also lead to lowering of coding efficiency.

Since direct mode does not use motion vector information, the mode has an effect of reducing header information for macroblocks. Especially in the case of a low bit rate, the mode contributes to enhancement in coding efficiency. As described earlier however, in the case of generating a prediction image by weighted prediction with reference to the L0 and L1 reference regions, the off-screen pixel values may be different from the actual ones, such that large difference will occur between the prediction image and source signals; for this reason, direct mode is hardly chosen, which may lead to lowering of coding efficiency.

On the other hand, in Non-patent Document 1 described above, in the case where a reference region contains an off-screen portion in direct mode, it is proposed that the reference picture is not used and the other reference picture is adopted for use, so as to increase the chance of choice of direct mode.

In this proposal, however, since one of the reference pictures is discarded, weighted prediction is not performed; thus, enhancement in prediction performance by weighted prediction is not expected much. In other words, in the proposal according to Non-patent Document 1, even in the case where a reference region is mostly on-screen and a little portion thereof is off-screen, the reference region is entirely discarded.

Further, Non-patent Document 1 merely proposes improvement of direct mode and does not mention bi-predictive prediction.

The present invention was made in view of the foregoing circumstances, for improving prediction accuracy for B pictures, especially in the vicinity of edges of screens.

### Solutions to Problems

An image processing apparatus according to one aspect of the present invention includes motion prediction compensating means for performing, in prediction using a plurality of different reference images to be referenced for an image to be processed, weighted prediction according to whether or not pixels to be referenced for a block in the image are off-screen in the plurality of reference images.

The motion prediction compensating means may be adapted to perform, in the case where reference for the block in the image is on-screen pixels in the plurality of reference images, standardized weighted prediction by using the pixels, and the motion prediction compensating means may be adapted to perform, in the case where reference for the block in the image is off-screen pixels in any one of the plurality of reference images and is on-screen pixels in the other of the reference images, the weighted prediction by using these pixels.

A larger weight may be placed on the on-screen pixels than on the off-screen pixels.

A weight for use in the weighted prediction may be 0 or 1.

The image processing apparatus may further include weight calculating means for calculating the weight for the weighted prediction based on discontinuity between pixels in the vicinity of the block in the image.

The image processing apparatus may further include encoding means for encoding information on the weight to be calculated by the weight calculating means.

The image processing apparatus may further include decoding means for decoding the information on the weight to be calculated based on discontinuity between pixels in the vicinity of the block in the image and to be encoded, and the motion prediction compensating means may be adapted to use the information on the weight to be decoded by the decoding means for performing the weighted prediction.

The prediction using a plurality of different reference images may be at least one of bi-predictive prediction or direct mode prediction.

A method of processing images according to one aspect of the present invention, for use in an image processing apparatus including motion prediction compensating means, includes performing, in prediction using a plurality of different reference images to be referenced for an image to be processed, weighted prediction by the motion prediction compensating means according to whether or not reference for a block in the image is off-screen in the plurality of reference images.

A program according to one aspect of the present invention is adapted to cause a computer to perform a function as motion prediction compensating means for performing, in prediction using a plurality of different reference images to be referenced for an image to be processed, weighted prediction according to whether or not reference for a block in the image is off-screen in the plurality of reference images.

According to one aspect of the present invention, in prediction using a plurality of different reference images to be referenced for an image to be processed, weighted prediction is performed according to whether or not reference for a block in the image is off-screen in the plurality of reference images.

The above image processing apparatus may be an independent apparatus or may be an internal block configuring one image coding apparatus or image decoding apparatus.

### Effects of the Invention

The present invention achieves improvement in prediction accuracy especially in the vicinity of edges of screens in B pictures. Hence, improvement in coding efficiency is achievable.

### BRIEF DESCRIPTION OF DRAWINGS

FIG. 1 is an explanatory view of inter prediction of related art.

FIG. 2 is a detailed explanatory view of the inter prediction of the related art.

FIG. 3 is an explanatory view of block sizes.

FIG. 4 is an explanatory view of interpolation.

FIG. 5 is an explanatory view of processing to be performed at the edge of a screen.

FIG. 6 is an explanatory view of bidirectional prediction.

FIG. 7 depicts relationship between coding modes and reference pictures and motion vectors.

FIG. 8 is an explanatory view of weighted prediction of related art.

FIG. 9 is a block diagram depicting the configuration of one embodiment of an image coding apparatus to which the present invention is applied.

FIG. 10 is an explanatory view of weighted prediction of the image coding apparatus of FIG. 9.

FIG. 11 is a block diagram of a configuration example of a motion compensator.

FIG. 12 is a flowchart for describing encoding processing of the image coding apparatus of FIG. 9.

FIG. 13 is a flowchart for describing prediction mode selection processing of the image coding apparatus of FIG. 9.

FIG. 14 is a flowchart for describing B picture compensation processing of the image coding apparatus of FIG. 9.

FIG. 15 is an explanatory view of a prediction block.

FIG. 16 depicts correspondence relationship between reference pixel positions and processing methods.

FIG. 17 is an explanatory view of an effect obtainable in the example of FIG. 14.

FIG. 18 is a block diagram depicting the configuration of one embodiment of an image decoding apparatus to which the present invention is applied.

FIG. 19 is a block diagram depicting a configuration example of a motion compensator of FIG. 18.

FIG. 20 is a flowchart for describing decoding processing of the image decoding apparatus of FIG. 18.

FIG. 21 is an exemplary view of extended block sizes.

FIG. 22 is a block diagram of a configuration example of computer hardware.

FIG. 23 is a block diagram depicting a main configuration example of a television receiver to which the present invention is applied.

FIG. 24 is a block diagram depicting a main configuration example of a mobile phone to which the present invention is applied.

FIG. 25 is a block diagram depicting a main configuration example of a hard disk recorder to which the present invention is applied.

FIG. 26 is a block diagram of a main configuration example of a camera to which the present invention is applied.

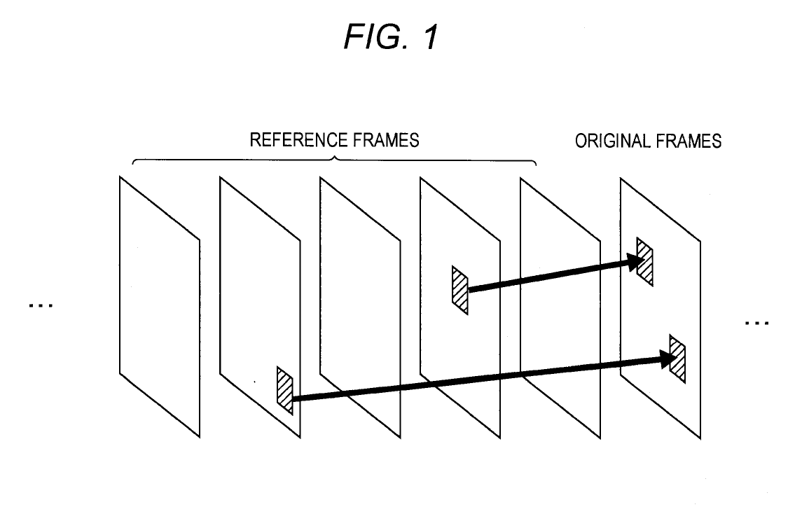

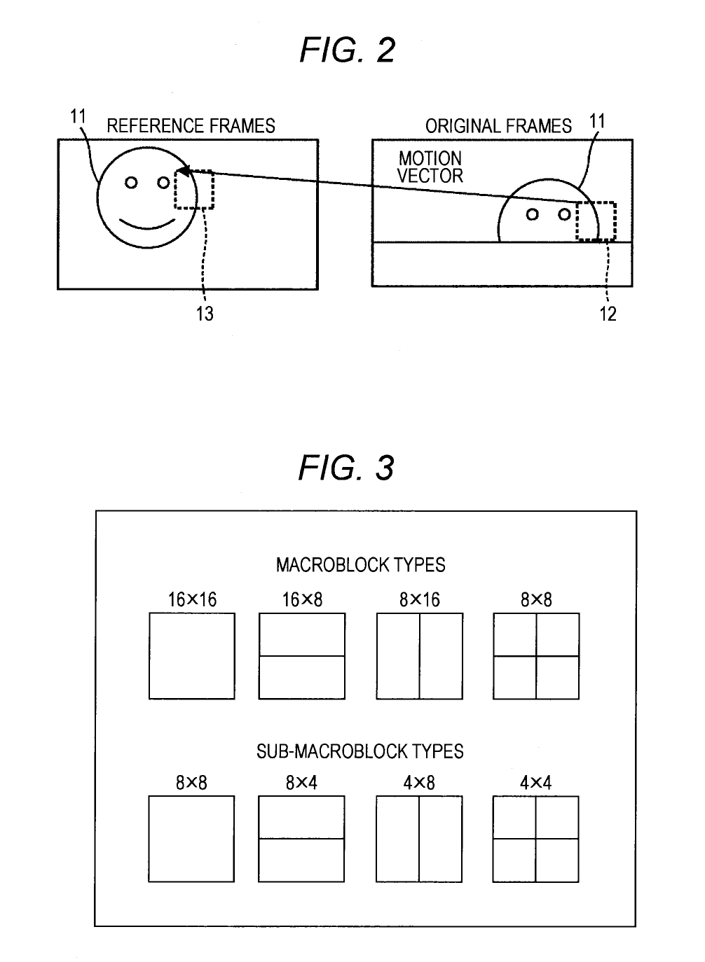

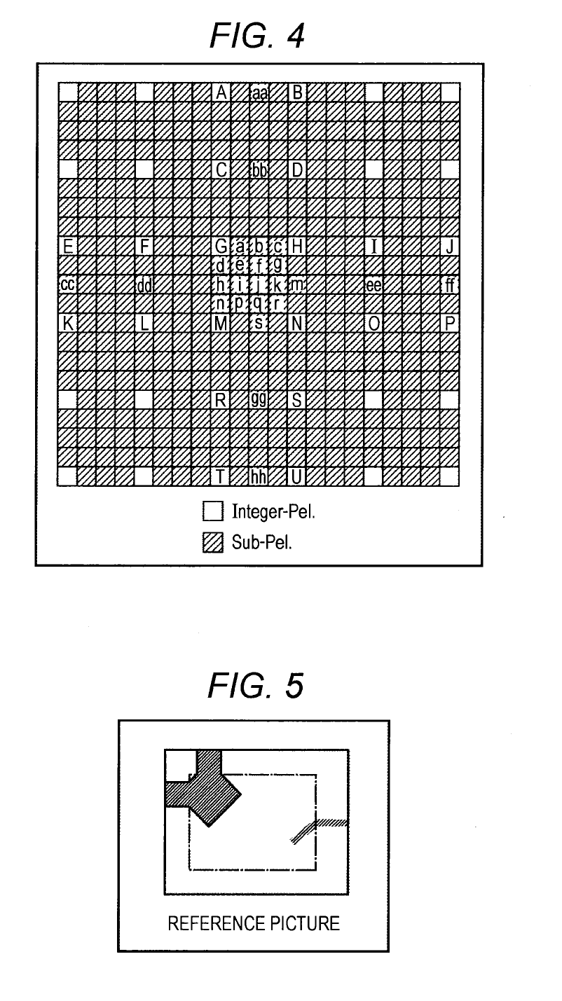

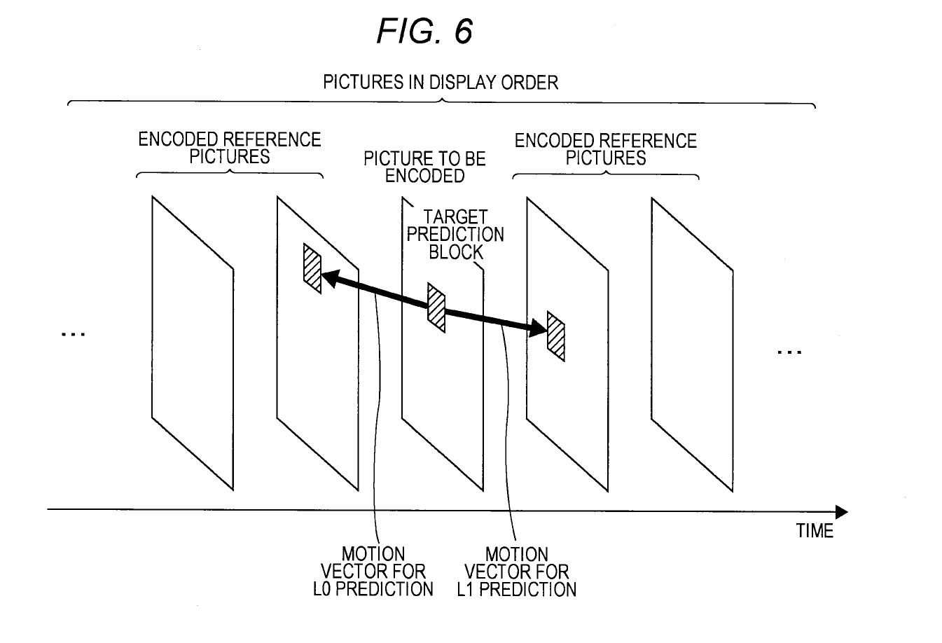

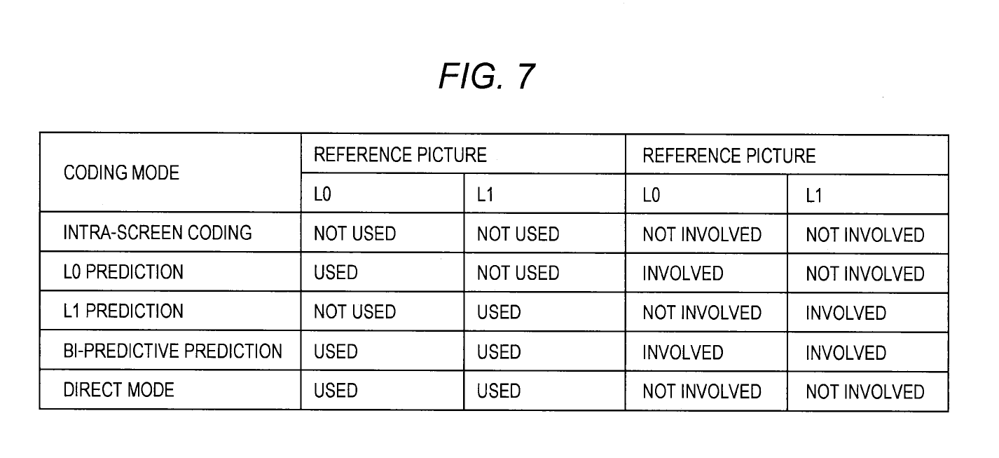

### MODE FOR CARRYING OUT THE INVENTION

Embodiments of the present invention are described below with reference to the drawings.

### [Configuration Example of Image Coding Apparatus]

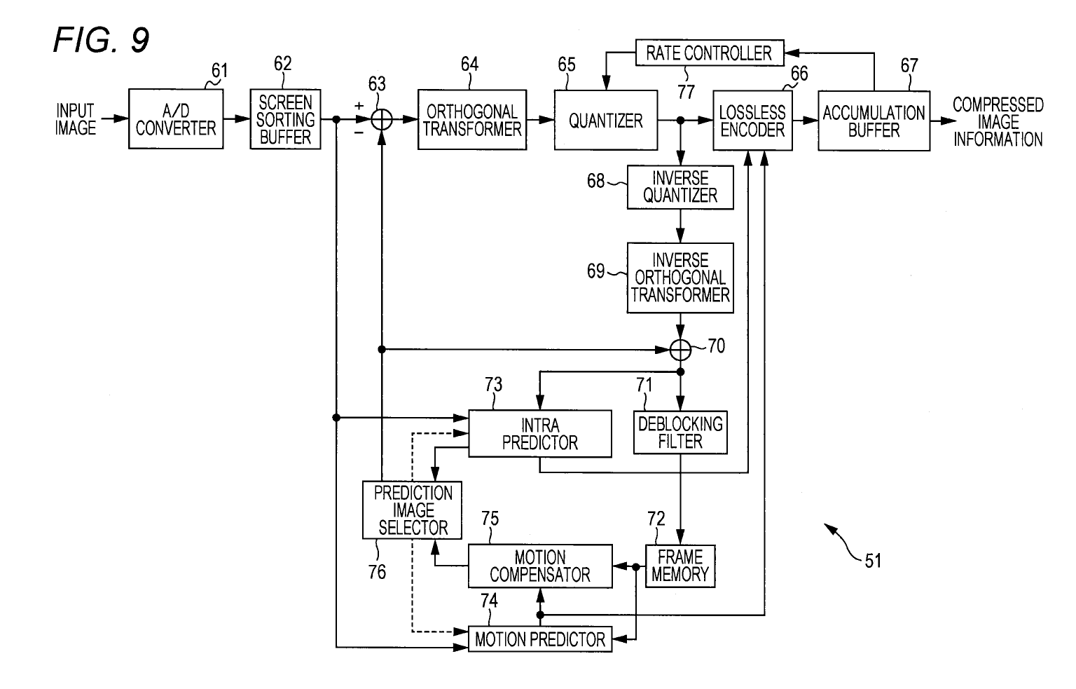

FIG. 9 depicts a configuration of one embodiment of an image coding apparatus serving as an image processing apparatus to which the present invention is applied.

An image coding apparatus 51 is configured to compress and encode images to be inputted based on, for example, H.264 and MPEG-4 Part10 (Advanced Video Coding) (hereinafter referred to as “H.264/AVC”) standard.

In the example of FIG. 9, the image coding apparatus 51 includes an A/D converter 61, a screen sorting buffer 62, an arithmetic operator 63, an orthogonal transformer 64, a quantizer 65, a lossless encoder 66, an accumulation buffer 67, an inverse quantizer 68, an inverse orthogonal transformer 69, an arithmetic operator 70, a deblocking filter 71, a frame memory 72, an intra predictor 73, a motion predictor 74, a motion compensator 75, a prediction image selector 76, and a rate controller 77.

The A/D converter 61 performs A/D conversion on inputted images for output to the screen sorting buffer 62 such that the converted images are stored thereon. The screen sorting buffer 62 sorts images of frames in the stored display order into an order of frames for encoding according to Gops (Groups of Pictures).

The arithmetic operator 63 subtracts, from the images read from the screen sorting buffer 62, prediction images that have been outputted either from the intra predictor 73 or from the motion compensator 75 and been selected by the prediction image selector 76, so as to output the difference information to the orthogonal transformer 64. The orthogonal transformer 64 performs orthogonal transform, such as discrete cosine transform or Karhunen-Loeve transform, on the difference information from the arithmetic operator 63 and outputs the transform coefficients. The quantizer 65 quantizes the transform coefficients outputted from the orthogonal transformer 64.

The quantized transform coefficients, which are the outputs from the quantizer 65, are inputted to the lossless encoder 66 so as to be subjected there to lossless coding such as variable length coding or binary arithmetic coding, for compression.

The lossless encoder 66 obtains information indicating intra prediction from the intra predictor 73 and obtains, for example, information indicating inter prediction mode from the motion compensator 75. The information indicating intra prediction and the information indicating inter prediction are also referred to as “intra prediction mode information” and “inter prediction mode information,” respectively.

The lossless encoder 66 encodes the quantized transform coefficients as well as, for example, information indicating intra prediction and information indicating inter prediction mode and includes the encoded information into header information for compressed images. The lossless encoder 66 supplies the encoded data to the accumulation buffer 67 for accumulation.

For example, lossless encoding processing such as variable length coding or binary arithmetic coding is performed at the lossless encoder 66. Examples of the variable length coding include CAVLC (Context-Adaptive Variable Length Coding) defined by H.264/AVC standard. Examples of the binary arithmetic coding include CABAC (Context-Adaptive Binary Arithmetic Coding.)

The accumulation buffer 67 outputs data supplied from the lossless encoder 66 to, for example, a recording apparatus or a channel at the later stage (not shown), as encoded compressed images.

The quantized transform coefficients outputted from the quantizer 65 are also inputted to the inverse quantizer 68 to be subjected to inverse quantization, followed by inverse orthogonal transform at the inverse orthogonal transformer 69. The inverse orthogonal transformed outputs are added by the arithmetic operator 70 to prediction images to be supplied from the prediction image selector 76 so as to constitute a locally decoded image.

The decoded images from the arithmetic operator 70 are outputted to the intra predictor 73 and the deblocking filter 71 as reference images for images about to be encoded. The deblocking filter 71 removes block distortion in the decoded images to supply the images to the frame memory 72 for accumulation thereon. The frame memory 72 outputs the accumulated reference images to the motion predictor 74 and the motion compensator 75.

In the image coding apparatus 51, for example, I pictures, B pictures, and P pictures from the screen sorting buffer 62 are supplied to the to the intra predictor 73 as images for intra prediction (also referred to as “intra processing.”) Further, B pictures and P pictures read from the screen sorting buffer 62 are supplied to the motion predictor 74 as images for inter prediction (also referred to as “inter processing.”)

The intra predictor 73 performs intra prediction processing in all candidate intra prediction modes based on the images to be subjected to intra prediction that are read from the screen sorting buffer 62 and the reference images outputted from the arithmetic operator 70, so as to generate prediction images.

At this time, the intra predictor 73 calculates cost function values for all the candidate intra prediction modes and selects as an optimum intra prediction mode an intra prediction mode to which a minimum cost function value is given by the calculation.

The intra predictor 73 supplies the prediction images generated in the optimum intra prediction mode and the cost function values thereof to the prediction image selector 76. The intra predictor 73 supplies, in the case where a prediction image generated in the optimum intra prediction mode is selected by the prediction image selector 76, the information indicating the optimum intra prediction mode to the lossless encoder 66. The lossless encoder 66 encodes the information to include the information into header information for compressed images.

The motion predictor 74 performs motion prediction on blocks in all the candidate inter prediction modes based on the images to be subjected to inter processing and the reference images from the frame memory 72, so as to generate motion vectors of the blocks. The motion compensator 74 outputs the generated motion vector information to the motion compensator 75.

The motion predictor 74 outputs, in the case where a prediction image of a target block in the optimum inter prediction mode is selected by the prediction image selector 76, information such as the information indicating the optimum inter prediction mode (inter prediction mode information), motion vector information, and reference frame information to the lossless encoder 66.

The motion compensator 75 performs interpolation filtering on the reference images from the frame memory 72. The motion compensator 75 performs compensation processing on the filtered reference images for blocks in all the candidate inter prediction modes by using motion vectors obtained based on motion vectors from the motion predictor 74 or on motion vectors in the peripheral blocks, so as to generate prediction images. At this time, the motion compensator 75 performs, in the case of a B picture in direct mode or bi-predictive prediction mode, i.e., a prediction mode where a plurality of different reference images is used, weighted prediction according to whether or not the pixels to be referenced for the target block are off-screen in the reference images thereof, so as to generate a prediction image.

For example, performed at the motion compensator 75 is weighted prediction such that, in the case where the reference for the target block is off-screen in a first reference image and is on-screen in a second reference image, a smaller weight is placed on the first reference image and a larger weight is placed on the second reference image.

These weights may be calculated at the motion compensator 75, or alternatively, a fixed value may be used. In the case that the weights are calculated, the weights are supplied to the lossless encoder 66 to be added to the headers of compressed images, for transmission to the decoding side.

Moreover, the motion compensator 75 calculates cost function values of the blocks to be processed for all the candidate inter prediction modes, so as to decide an optimum inter prediction mode that has a minimum cost function value. The motion compensator 75 supplies prediction images and the cost function values thereof generated in the optimum inter prediction mode to the prediction image selector 76.

The prediction image selector 76 decides an optimum prediction mode from the optimum intra prediction mode and the optimum inter prediction mode based on the cost function values outputted from the intra predictor 73 or the motion compensator 75. Then, the prediction image selector 76 selects prediction images in the optimum prediction mode thus decided to supply the images to the arithmetic operators 63 and 70. At this time, the prediction image selector 76 supplies, as indicated by the dotted line, the information on selection of the prediction images to the intra predictor 73 or to the motion predictor 74.

The rate controller 77 controls the rate of the quantizing operation of the quantizer 65 based on the compressed images accumulated in the accumulation buffer 67 so as to protect from overflow or underflow.

### [Features of Motion Compensator]

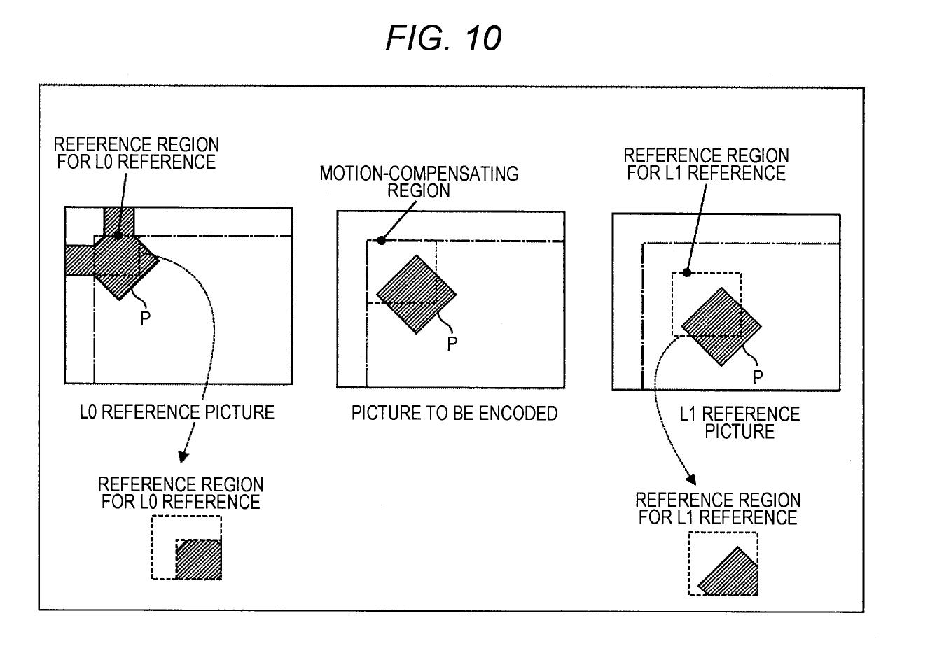

Description is given next of the motion compensator 75 with reference to FIG. 10.

At the motion compensator 75, in bi-predictive prediction or direct mode where two reference pictures (images) are used to perform weighted prediction, when both L0 and L1 reference pixels (pixels) are on-screen, weighted prediction according to H.264/AVC standard is performed. On the other hand, when reference pixels (pixels) either for L0 or L1 are off-screen and the reference pixels for the other are on-screen, prediction is performed by using the on-screen reference pixels.

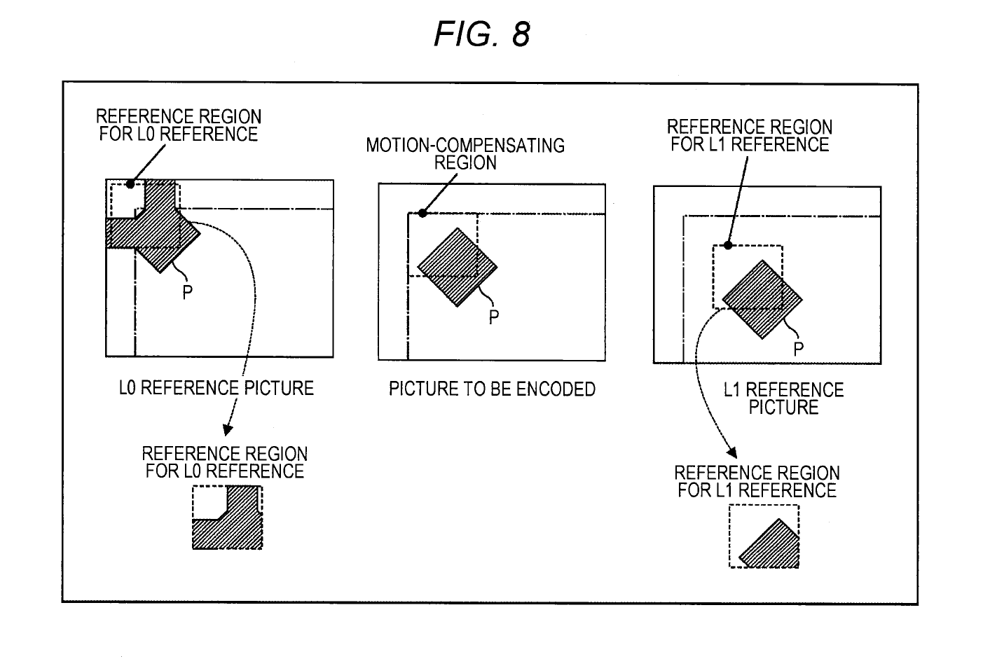

In the example of FIG. 10, as in the example of FIG. 8, an L0 reference picture, a picture to be encoded, and an L1 reference picture are depicted from the left in the order of time course. In the pictures, the chain lines indicate the edge of the screen, and the regions between the solid lines and the chain lines indicate regions extended by duplication at the edge of the screen as described earlier in connection with FIG. 5.

The regions enclosed with the dashed lines in the pictures indicate a reference region for L0 reference in the L0 reference picture, a motion-compensating region in the picture to be encoded, and a reference region for L1 reference in the L1 reference picture. The reference region for L0 reference and the reference region for L1 reference are extracted in the lower part of FIG. 10.

FIG. 10 depicts an example in which the hatched rhomboid object P in the picture to be encoded is moving from the upper left toward the lower right, and a portion of the object P transcends the edge of the screen to the outside in the L0 reference picture. In other words, the reference region in the L0 reference picture has an off-screen portion, and the reference region in the L1 reference picture is entirely on-screen.

Accordingly, the motion compensator 75 generates a prediction image by weighted prediction according to H.264/AVC standard with respect to the on-screen portion of the reference region in the L0 reference picture and, with respect to the off-screen portion of the reference region in the L0 reference picture, generates a prediction image not by using it but by using the reference region in the L1 reference picture. More specifically, in the L0 reference picture, as depicted in the reference region for L0 reference, the reference region is the dashed square on the outer side, but the region used for prediction is limited to the dashed square region on the inner side in actuality.

For example, of the reference region in the L0 reference picture, weighted prediction is performed on the off-screen portion with the weight on the reference region in the L0 reference picture being 0 and the weight on the reference region in the L1 reference picture being 1. The weights do not have to be 0 and/or 1, and the weight on the off-screen portion in a first reference region may be smaller than the weight on the on-screen potion in a second reference region. In this case, the weights may be fixed, or alternatively, optimal weights may be found by calculation.

In this manner, enhancement in prediction performance at edges of screens is achievable, since inaccurate information that is off-screen and are a duplicate of the on-screen pixel values is no longer used or otherwise the weight to be placed thereon is reduced.

### [Configuration Example of Motion Compensator]

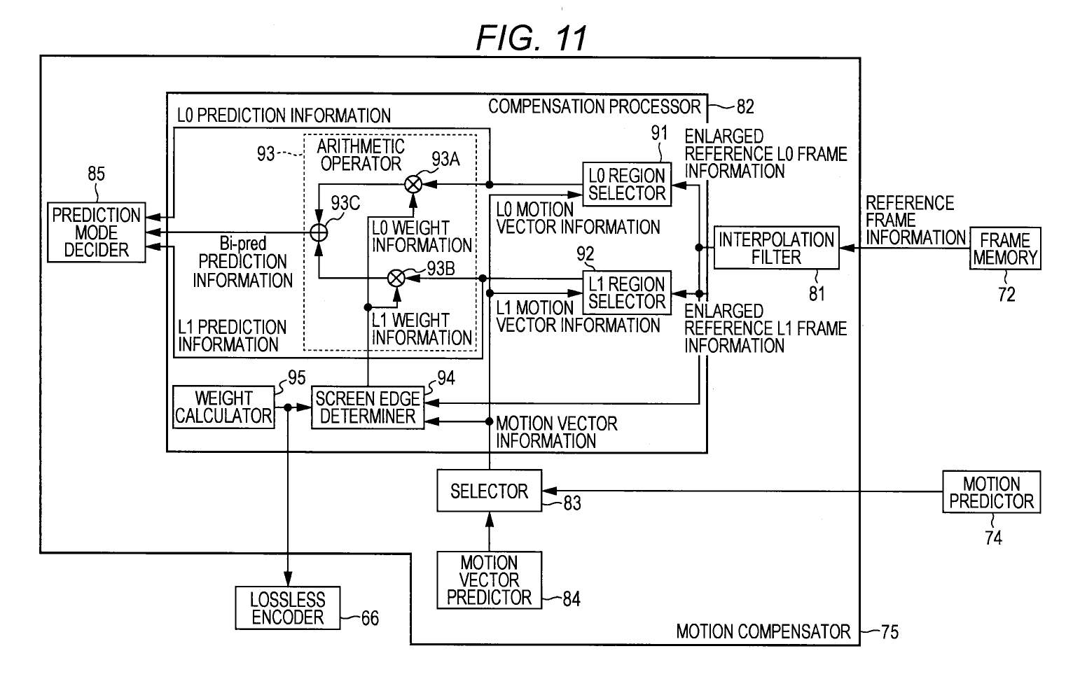

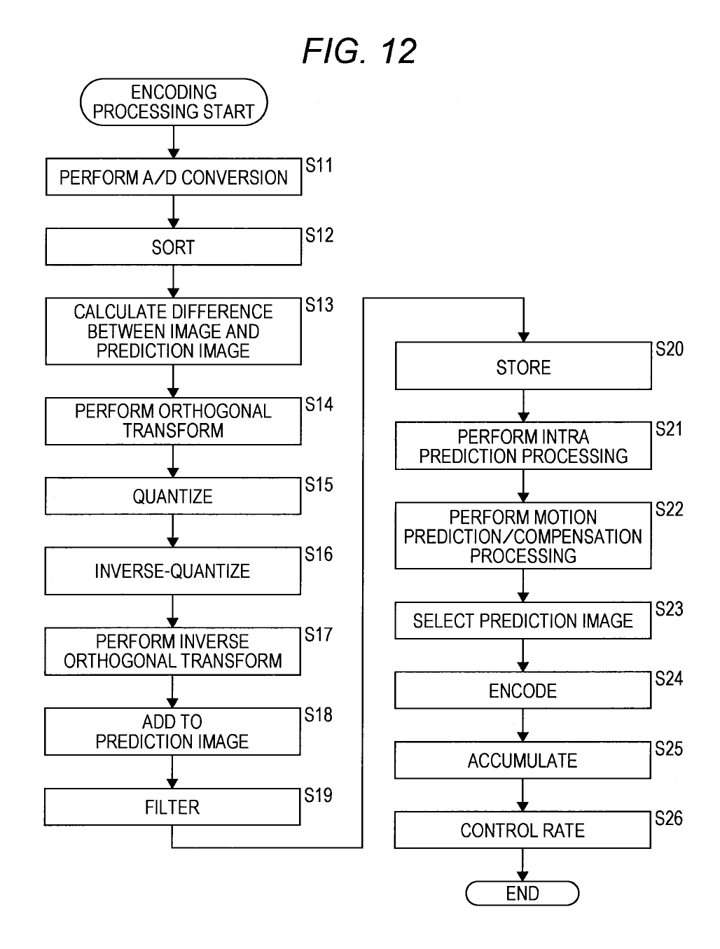

FIG. 11 depicts a configuration example of the motion compensator.

The motion compensator 75 of FIG. 11 includes an interpolation filter 81, a compensation processor 82, a selector 83, a motion vector predictor 84, and a prediction mode decider 85.

Reference frame (reference image) information from the frame memory 72 is inputted to the interpolation filter 81. The interpolation filter 81 performs interpolation between pixels in the reference frames for vertical and lateral enlargement by four times and outputs the enlarged frame information to the compensation processor 82.

The compensation processor 82 includes an L0 region selector 91, an L1 region selector 92, an arithmetic operator 93, a screen edge determiner 94, and a weight calculator 95. In the compensation processor 82 of the example in FIG. 11, processing on B pictures is exemplarily depicted.

The enlarged reference frame information from the interpolation filter 81 is inputted to the L0 region selector 91, the L1 region selector 92, and the screen edge determiner 94.

The L0 region selector 91 selects from the enlarged L0 reference frame information a corresponding L0 reference region according to the prediction mode information and L0 motion vector information from the selector 83 and outputs the reference region information to the arithmetic operator 93. The information on the reference region thus outputted is inputted to the prediction mode decider 85 as L0 prediction information in the case of L0 prediction mode.

The L1 region selector 92 selects from the enlarged L1 reference frame information a corresponding L1 reference region according to the prediction mode information and L1 motion vector information from the selector 83 and outputs the reference region information to the arithmetic operator 93. The information on the reference region thus outputted is inputted to the prediction mode decider 85 as L1 prediction information in the case of L1 prediction mode.

The arithmetic operator 93 includes a multiplier 93A, a multiplier 93B, and an adder 93C. The multiplier 93A multiplies the L0 reference region information from the L0 region selector 91 by L0 weight information from the screen edge determiner 94, so as to output the result to the adder 93C. The multiplier 93B multiplies the L1 reference region information from the L1 region selector 92 by L1 weight information from the screen edge determiner 94, so as to output the result to the adder 93C. The adder 93C adds the L0 reference region and the L1 reference region that have been allocated with weights based on the L0 and L1 weight information, so as to output the result to the prediction mode decider 85 as weighted prediction information (Bi-pred prediction information.)

The enlarged reference frame information from the interpolation filter 81 and the motion vector information from the selector 83 are supplied to the screen edge determiner 94. The screen edge determiner 94 determines whether or not the L0 reference pixels or the L1 reference pixels are off-screen based on those pieces of information and outputs weight factors to be supplied to the multiplier 93A and the multiplier 93B according to the result of determination. For example, in the case where the pixels for L0 and L1 are both on-screen or off-screen, a weight factor of W=0.5 is outputted. In the case where the pixels for either L0 or L1 are off-screen and for the other are on-screen, a smaller weight factor is given to at least the off-screen reference pixels than to the on-screen reference pixels.

The weight calculator 95 calculates weight factors for use in the case where either L0 reference pixels or the L1 reference pixels are off-screen according to the characteristics of the input images, so as to supply the factors to the screen edge determiner 94. The weight factors thus calculated are also outputted to the lossless encoder 66 for transmission to the decoding side.

The selector 83 selects, according to the prediction mode, either motion vector information searched by the motion predictor 74 or motion vector information found by the motion vector predictor 84 and supplies the selected motion vector information to the screen edge determiner 94, the L0 region selector 91, and the L1 region selector 92.

The motion vector predictor 84 predicts motion vectors according to a mode in which motion vectors are not transmitted to the decoding side, such as skip mode or direct mode, and supplies the motion vectors to the selector 83.

This method of predicting motion vectors is similar to that according to H.264/AVC standard, and prediction, such as spatial prediction that effects prediction by means of median prediction based on motion vectors in the peripheral blocks and temporal prediction that effects prediction based on motion vectors in co-located blocks, is performed depending on the modes at the motion vector predictor 84. A co-located block is a block in a picture (a picture located forward or backward) that is different from the picture of the target block and exists at the position corresponding to the target block.

In the example of FIG. 11, although not shown, for example, motion vector information in the peripheral blocks to be found is available from the selector 83.

### [Description of Weight Factor]

The weight factor information to be supplied according to the result of determination by the screen edge determiner 94 and to be multiplied at the arithmetic operator 93 is, in the case where the reference pixels for either L0 or L1 are off-screen, a weight to be multiplied to the reference pixels for the other. The value thereof is in the range of 0.5 to 1 and makes 1 when added to the weight to be multiplied to the off-screen pixels for the other.

Hence, where the L0 weight factor information is W_{L0}, the L1 weight factor information is W_{L1}=1−W_{L0}. As a result, the calculation to be performed at the arithmetic operator 93 of FIG. 11 is represented as the following equation (3):

Y=W_{L0}I_{L0}+(1−W_{L0})I_{L1} (3)

where Y is the weighted prediction signal, I_{L0} is the L0 reference pixel, and I_{L1} is the L1 reference pixel.

Further, these weight factors are calculable by the weight calculator 95. At the weight calculator 95, for example, weights are calculated based on the strength of correlation between pixels. In the case where correlation is weaker between on-screen adjacent pixels, i.e., where great difference exists between adjacent pixel values, the pixel values resulting from duplication of pixels at the edge of a screen have a lower degree of reliability, and the weight information W is thus closer to 1, whereas in the case where the correlation is stronger, like H.264/AVC standard, the pixel values resulting from duplication of the pixels at the edge of the screen have a higher degree of reliability, and the weight information W is thus closer to 0.5.

Methods of checking the degree of strength of correlation between pixels include a method of calculating an on-screen average of the absolute values of differences between adjacent pixels, a method of calculating the magnitude of dispersion of pixel values, and a checking method wherein the spectrum of high-frequency components is found by means of, for example, the Fourier transform.

As a simplest example, the weight W may be fixed to 1 on the assumption that the off-screen portion is unreliable. In this case, the weight information need not be transmitted to the decoding side and thus does not have to be contained in the stream information.

Further, since the weight for the off-screen portion is 0, the multiplier 93A, the multiplier 93B, and the adder 93C of the arithmetic operator 93 may be eliminated, and a simpler selection circuit may be provided instead.

### [Description of Encoding Processing at Image Coding Apparatus]

Description is given next of the encoding processing at the image coding apparatus 51 of FIG. 9 with reference to the flowchart of FIG. 12.

In step S11, the A/D converter 61 performs A/D conversion on input images. In step S12, the screen sorting buffer 62 retains the images supplied from the A/D converter 61 and sorts the pictures thereof from the display order into the encoding order.

In step S13, the arithmetic operator 63 calculates difference between the images sorted in step S12 and prediction images. The prediction images are supplied through the prediction image selector 76 from the motion compensator 75 in the case of inter prediction and from the intra predictor 73 in the case of intra prediction, to the arithmetic operator 63.

The difference data has a smaller data amount as compared with the original image data. Thus, the data amount is compressed in comparison with the case of encoding the image itself.

In step S14, the orthogonal transformer 64 performs orthogonal transform on the difference information supplied from the arithmetic operator 63. Specifically, orthogonal transform such as discrete cosine transform or Karhunen-Loeve transform is performed, such that transform coefficients are outputted. In step S15, the quantizer 65 quantizes the transform coefficients. In quantizing, the rate is controlled as described in the processing in step S26 to be described later.

The difference information thus quantized is decoded locally as described hereinafter. Specifically, in step S16, the inverse quantizer 68 performs inverse quantization on the transform coefficients quantized by the quantizer 65 with the characteristics corresponding to the characteristics of the quantizer 65. In step S17, the inverse orthogonal transformer 69 performs inverse orthogonal transform on the transform coefficients inverse-quantized by the inverse quantizer 68 with the characteristics corresponding to the characteristics of the orthogonal transformer 64.

In step S18, the arithmetic operator 70 adds prediction images to be inputted through the prediction image selector 76 to the locally decoded difference information and generates locally decoded images (images corresponding to the inputs to the arithmetic operator 63.) In step S19, the deblocking filter 71 filters the images outputted from the arithmetic operator 70, so as to remove block distortion. In step S20, the frame memory 72 stores the images filtered.

In step S21, the intra predictor 73 performs intra prediction processing. Specifically, the intra predictor 73 performs intra prediction processing in all candidate intra prediction modes based on the images for intra prediction that have been read from the screen sorting buffer 62 and the images supplied from the arithmetic operator 70 (images yet to be filtered), so as to generate intra prediction images.

The intra predictor 73 calculates cost function values for all the candidate intra prediction modes. The intra predictor 73 decides, of the calculated cost function values, an intra prediction mode that has given a minimum value as an optimum intra prediction mode. Then, the intra predictor 73 supplies to the prediction image selector 76 intra prediction images generated in the optimum intra prediction mode and the cost function values thereof.

In the case where the processing target images to be supplied from the screen sorting buffer 62 are images to be subjected to inter processing, images to be referenced are read from the frame memory 72 and are supplied to the motion predictor 74 and the motion compensator 75 through a switch 73.

In step S22, the motion predictor 74 and the motion compensator 75 perform motion prediction/compensation processing. Specifically, the motion predictor 74 performs motion prediction on blocks in all the candidate inter prediction modes based on the images to be subjected to inter processing and the reference images from the frame memory 72 and generates motion vectors of the blocks. The motion compensator 74 outputs the information on the generated motion vectors to the motion compensator 75.

The motion compensator 75 performs interpolation filtering on the reference images from the frame memory 72. The motion compensator 75 uses motion vectors that have been found based on the motion vectors from the motion predictor 74 or motion vectors of the peripheral blocks to perform compensation processing on the filtered reference images for the blocks in all the candidate inter prediction modes and generates prediction images.

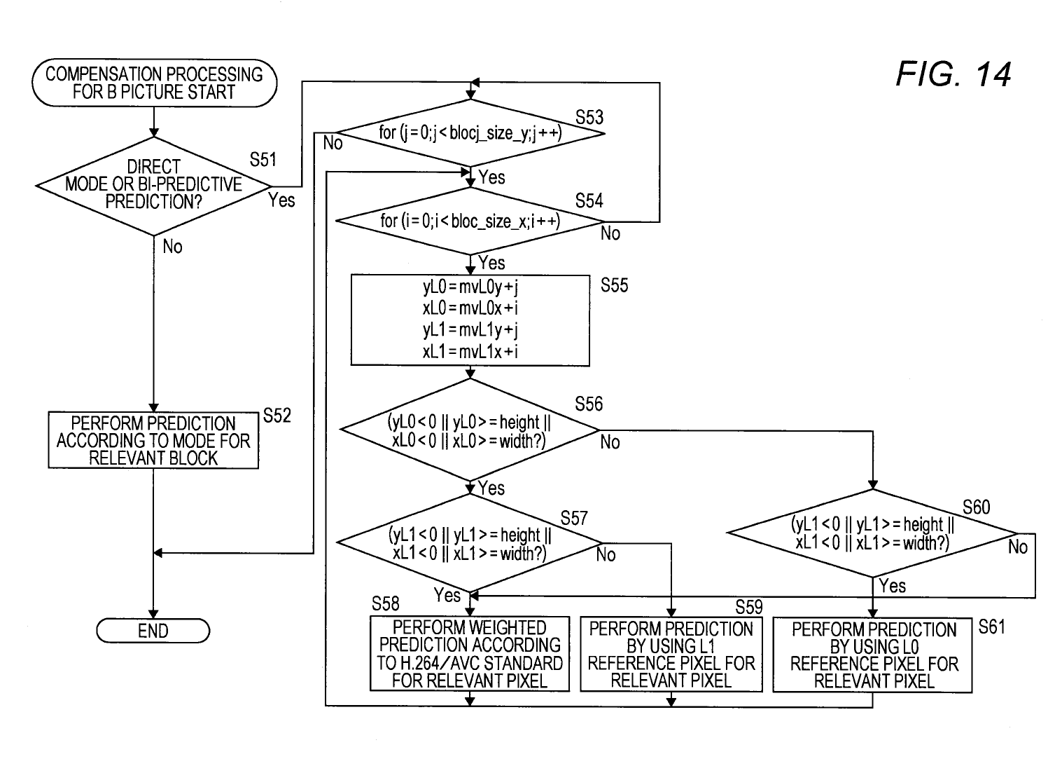

At this time, the motion compensator 75, in the case of a B picture in direct mode or bi-predictive prediction mode, i.e. in a prediction mode where a plurality of difference reference images are used, performs weighted prediction according to whether or not the pixels to be referenced for the target block are off-screen in the reference images thereof, so as to generate a prediction image. The compensation processing for B pictures is described later with reference to FIG. 14.

Further, the motion compensator 75 finds cost function values on the blocks to be processed for all the candidate inter prediction modes and decides an optimum inter prediction mode having a minimum cost function value. The motion compensator 75 supplies to the prediction image selector 76 prediction images generated in the optimum inter prediction mode and the cost function values thereof.

In step S23, the prediction image selector 76 decides, based on the cost function values that have been outputted from the intra predictor 73 and the motion compensator 75, either the optimum intra prediction mode or the optimum inter prediction mode as an optimum prediction mode. Then, the prediction image selector 76 selects prediction images in the decided optimum prediction mode and supplies the images to the arithmetic operators 63 and 70. As described earlier, these prediction images are used for the arithmetic operations in steps S13 and S18.

As indicated by the dotted line in FIG. 9, the selection information on the prediction images is supplied to the intra predictor 73 or to the motion predictor 74. In the case where a prediction image in the optimum intra prediction mode is selected, the intra predictor 73 supplies the information indicating the optimum intra prediction mode (i.e., the intra prediction mode information) to the lossless encoder 66.

In the case where a prediction image in the optimum inter prediction mode is selected, the motion predictor 74 outputs the information indicating the optimum inter prediction mode, motion vector information, and reference frame information to the lossless encoder 66. In the case where weights are calculated at the motion compensator 75, the information that the inter prediction image has been selected is also supplied to the motion compensator 75, and thus the motion compensator 75 outputs the calculated weight factor information to the lossless encoder 66.

In step S24, the lossless encoder 66 encodes the quantized transform coefficients that have been outputted from the quantizer 65. In other words, the difference images are subjected to lossless coding such as variable length coding or binary arithmetic coding for compression. At this time, the intra prediction mode information from the intra predictor 73 or the optimum inter prediction mode from the motion compensator 75 that has been inputted to the lossless encoder 66 in the above-described step S23, as well as the pieces of information as mentioned above, is encoded to be included into the header information.

For example, the information indicating the inter prediction mode is encoded per macroblock. The motion vector information and the reference frame information are encoded per target block. The information on the weight factors may be based on frames, or alternatively, may be based on sequences (scenes from the start to end of photographing.)

In step S25, the accumulation buffer 67 accumulates difference images as compressed images. The compressed images thus accumulated in the accumulation buffer 67 are appropriately read therefrom to be transmitted to the decoding side through a channel.

In step S26, the rate controller 77 controls the rate of quantizing operation of the quantizer 65 based on the compressed images accumulated in the accumulation buffer 67 so as to protect from overflow or underflow.

### [Description of Prediction Mode Selection Processing]

In the image coding apparatus 51 of FIG. 9, for encoding a relevant macroblock, an optimum mode has to be decided from among a plurality of prediction modes. A typical deciding method is based on the multipath encoding method, and motion vectors, reference pictures, and prediction modes are decided so as to minimize the cost (i.e., the cost function values) by using the following equation (4) or (5):

Cost=SATD+λ_{Motion}GenBit (4)

Cost=SSD+λ_{Mode}GenBit (5)

Herein, SATD (Sum of Absolute Transformed Difference) is the sum of the absolute values of prediction errors performed with the Hadamard transform. SSD (Sum of Square Difference) is the sum of squared errors, which is the grand sum of the squares of prediction errors of pixels. GenBit (Generated Bit) is the bit amount to occur in the case of encoding the relevant macroblock in relevant candidate modes. λ_{Motion} and λ_{Mode} are variables referred to as “Lagrange multipliers” that are decided according to the quantization parameter QP and whether the picture is an I/P picture or a B picture.

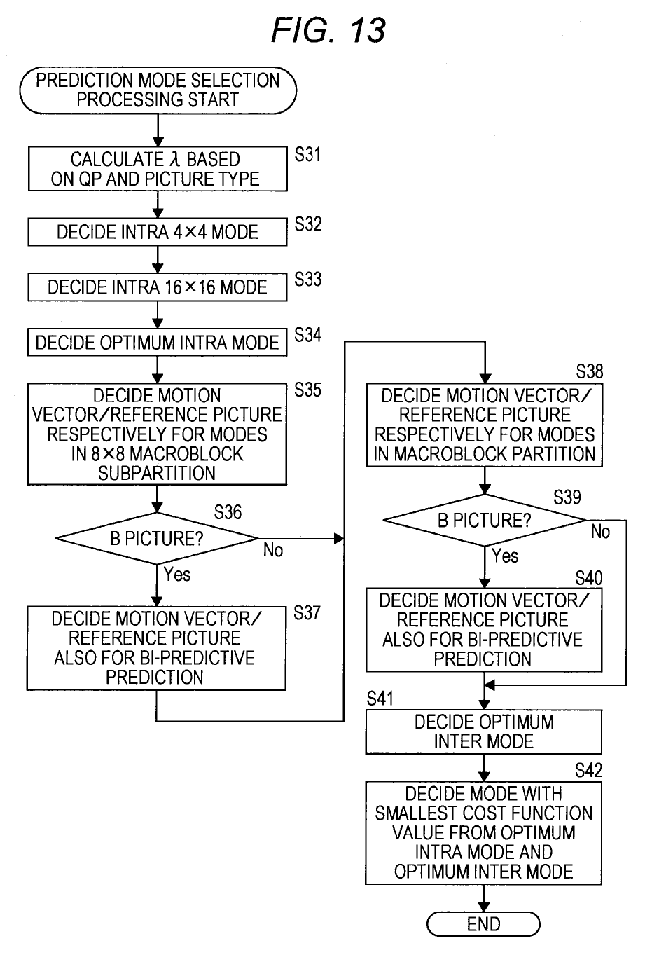

The prediction mode selection processing of the image coding apparatus 51 by using the above-described equation (4) or (5) is described with reference to FIG. 13. The prediction mode selection processing is processing with the focus on the prediction mode selection in steps S21 to S23 in FIG. 12.

In step S31, the intra predictor 73 and the motion compensator 75 (the prediction mode decider 85) calculates λ according to the quantization parameter QP and the picture type, respectively. Although the indicative arrow therefor is not shown, the quantization parameter QP is supplied from the quantizer 65.

In step S32, the intra predictor 73 decides an intra 4×4 mode such that the cost function value takes a smaller value. The intra 4×4 mode includes nine kinds of prediction modes, and one of the modes that has the smallest cost function value is determined as the intra 4×4 mode.

In step S33, the intra predictor 73 decides an intra 16×16 mode such that the cost function value takes a smaller value. The intra 16×16 mode includes four kinds of prediction modes, and one of the modes that has the smallest cost function value is decided as the intra 16×16 mode.

Then, in step S34, the intra predictor 73 decides either the intra 4×4 mode or the intra 16×16 mode which has a smaller cost function value as an optimum intra mode. The intra predictor 73 supplies to the prediction image selector 76 prediction images obtained in the decided optimum intra mode and the cost function values thereof.

The processing from the above steps S32 to S34 corresponds to the processing of step S21 in FIG. 12.

In step S35, the motion predictor 74 and the motion compensator 75 decide motion vectors and reference pictures such that the cost functions take smaller values in the unit of 8×8 macroblock subpartition that is depicted in the lower portion of FIG. 3 for the following modes: The modes include 8×8, 8×4, 4×8, 4×4, and in the case of B pictures, direct mode is included.

In step S36, the motion predictor 74 and the motion compensator 75 determine whether or not the image under processing is a B picture, and when it is determined that the image is a B picture, the processing proceeds to step S37. The motion predictor 74 and the motion compensator 75 decide, in step S37, motion vectors and reference pictures such that the cost functions take smaller values also for bi-predictive prediction.

In step S36, when it is determined that the image is not a B picture, step S37 is skipped and the processing proceeds to step S38.

In step S38, the motion predictor 74 and the motion compensator 75 decide motion vectors and reference pictures such that the cost functions take smaller values in the unit of macroblock partitions that are depicted in the upper portion of FIG. 3 for the following modes: The modes include 16×16, 16×8, 8×16, direct mode, and skip mode.

In step S39, the motion predictor 74 and the motion compensator 75 determine whether or not the image under processing is a B picture, and when it is determined that the image is a B picture, the processing proceeds to step S40. The motion predictor 74 and the motion compensator 75 decide, in step S40, motion vectors and reference pictures such that the cost functions take smaller values also for bi-predictive prediction.

In step S39, when it is determined that the image is not a B picture, step S40 is skipped and the processing proceeds to step S41.

Then, in step S41, (the prediction mode decider 85 of) the motion compensator 75 decides a mode which has a smaller cost function value from among the above-described macroblock partitions and the sub-macroblock partitions as an optimum inter mode. The prediction mode decider 85 supplies to the prediction image selector 76 prediction images obtained in the decided optimum inter mode and the cost function values thereof.

The processing from the above steps S35 to S41 corresponds to the processing of step S22 in FIG. 12.

In step S42, the prediction image selector 76 decides a mode which has the smallest cost function value from the optimum intra mode and the optimum inter mode. The processing of step S42 corresponds to the processing of step S23 in FIG. 12.

As described above, motion vectors and reference pictures (for inter), and the prediction mode are decided. For example, in deciding motion vectors for bi-predictive prediction and direct mode in the case of B pictures in steps S37 and S40 in FIG. 13, use is made of prediction images that are compensated by the processing in FIG. 14 to be described below.

FIG. 14 is a flowchart for describing compensation processing in the case of B pictures. In other words, FIG. 14 illustrates processing specifically for B pictures of the motion prediction/compensation processing in step 22 in FIG. 12. In the example of FIG. 14, for the sake of easy understanding, a case is described in which the weight factor is 0 for the off-screen reference pixel and the weight factor is 1 for the on-screen reference pixel.

In step S51, the selector 83 determines whether or not the processing target mode is direct mode or bi-predictive prediction. In step S51, when the mode is neither direct mode nor bi-predictive prediction, the processing proceeds to step S52.

In step S52, the compensation processor 82 performs prediction for relevant blocks according to the mode (L0 prediction or L1 prediction.)

Specifically, in the case of L0 prediction, the selector 83 sends prediction mode information and L0 motion vector information restrictively to the L0 region selector 91. The L0 region selector 91 selects from enlarged L0 reference frame information a corresponding L0 reference region according to the prediction mode (indicating L0 prediction) information and L0 motion vector information from the selector 83, for output to the prediction mode decider 85. The same processing is performed for L1.

In step S51, when it is determined that the mode is direct mode or bi-predictive prediction, the processing proceeds to step S53. In this case, prediction mode information and motion vector information from the selector 83 are supplied to the L0 region selector 91, the L1 region selector 92, and the screen edge determiner 94.

Correspondingly, the L0 region selector 91 selects from enlarged L0 reference frame information a corresponding L0 reference region according to the prediction mode (indicating direct mode or bi-predictive prediction) information and L0 motion vector information from the selector 83, for output to the arithmetic operator 93. The L1 region selector 92 selects from enlarged L1 reference frame information a corresponding L1 reference region according to the prediction mode information and L1 motion vector information from the selector 83, for output to the arithmetic operator 93.

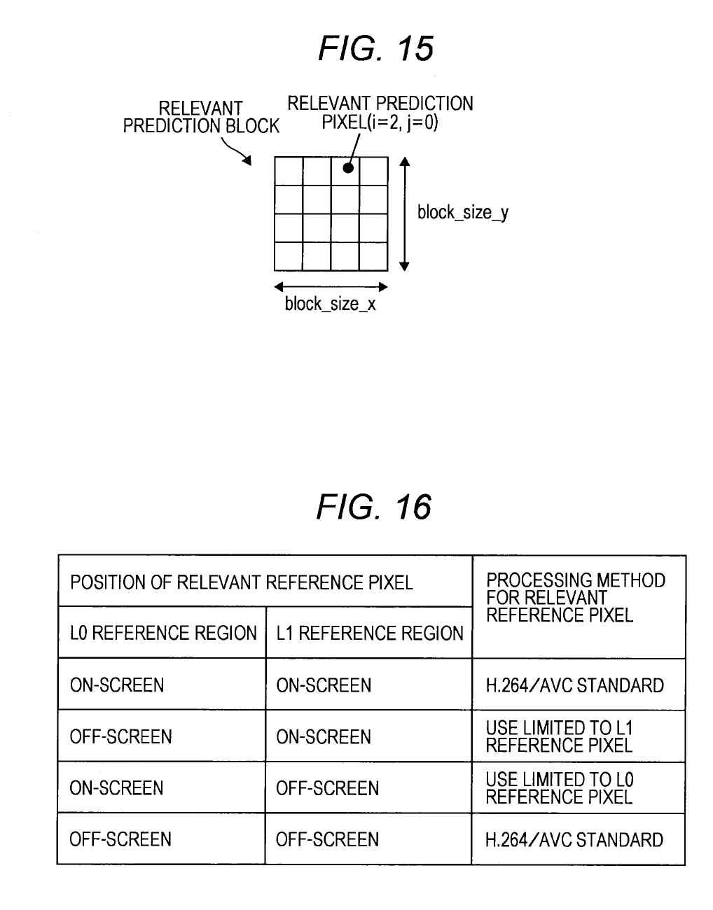

Then, the screen edge determiner 94 determines whether or not the reference pixels are off-screen in the following steps S53 to S57 and S60. In the description below, reference is made of the coordinates of a relevant prediction pixel in a relevant prediction block depicted in FIG. 15.

In FIG. 15, block_size_x indicates the size of the relevant prediction block in the x direction, whereas block_size_y indicates the size of the relevant prediction block in the y direction. Further, i indicates the x coordinate of the relevant prediction pixel in the relevant prediction block, whereas j indicates the y coordinate of the relevant prediction pixel in the relevant prediction block.

In the case of FIG. 15, as the exemplary relevant prediction block is constituted by 4×4 pixels, (block_size_x, block_size_y)=(4, 4), 0≦i, and j≦3. Hence, the prediction pixel depicted in FIG. 15 has the coordinates of x=i=2 and y=j=0.

In step S53, the screen edge determiner 94 determines whether or not j having a value from 0 is smaller than block_size_y and terminates the processing in the case where it is determined that j is larger than block_size_y. Meanwhile, in step S53, in the case where it is determined that j is smaller than block_size_y, i.e., that j is in the range of 0 to 3, the processing proceeds to step S54, and the processing thereafter is repetitively performed.

In step S54, the screen edge determiner 94 determines whether or not i having a value from 0 is smaller than block_size_x, and when it is determined that i is larger than block_size_x, the processing returns to step S53 and the processing thereafter is repetitively performed. Further, in step S54, in the case where it is determined that i is smaller than block_size_x, i.e., that i is in the range of 0 to 3, the processing proceeds to step S55, and the processing thereafter is repetitively performed.

In step S55, the screen edge determiner 94 uses L0 motion vector information mvL0x and mvL0y and L1 motion vector information mvL1x and mvL1y to find reference pixels. More specifically, the y coordinate yL0 and the x coordinate xL0 of the pixel to be referenced for L0 and the y coordinate yL1 and the x coordinate xL1 of the pixel to be referenced for L1 are given by the following equations (6).

yL0=mvL0y+j

xL0=mvL0x+i

yL1=mvL1y+j

xL1=mvL1x+i (6)

In step S56, the screen edge determiner 94 determines whether the y coordinate yL0 of the pixel to be reference for L0 is smaller than 0 or is equal to or larger than the height of the picture frame (height: the size of the screen in the y direction), or whether the x coordinate xL0 of the pixel to be reference for L0 is smaller than 0 or is equal to or larger than the width of the picture frame (width: the size of the screen in the x direction.)

In other words, in step S56, determination is made whether or not the following equation (7) is established.

[Formula 1]

yL0<0∥yL0>=height∥xL0<0∥xL0>=width (7)

In step S56, in the case where it is determined that the equation (7) is established, the processing proceeds to step S57. In step S57, the screen edge determiner 94 determines whether the y coordinate yL1 of the pixel to be referenced for L1 is smaller than 0 or is equal to or larger than the height of the picture frame (height: the size of the screen in the y direction), or whether the x coordinate xL1 of the pixel to be referenced for L1 is smaller than 0 or is equal to or larger than the width of the picture frame (width: the size of the screen in the x direction.)

In other words, in step S57, determination is made whether or not the following equation (8) is established.

[Formula 2]

yL1<0∥yL1>=height∥xL1<0∥xL1>=width (8)

In step S57, in the case where it is determined that the equation (8) is established, the processing proceeds to step S58. In this case, since the pixel to be referenced for L0 and the pixel to be referenced for L1 are both off-screen pixels, the screen edge determiner 94 supplies, for the relevant pixel, weight factor information of weighted prediction according to H.264/AVC standard to the arithmetic operator 93. Correspondingly, in step S58, the arithmetic operator 93 performs on the relevant pixel the weighted prediction according to H.264/AVC standard.

In step S57, in the case where it is determined that the equation (8) is not established, the processing proceeds to step S59. In this case, since the pixel to be referenced for L0 is an off-screen pixel and the pixel to be referenced for L1 is an on-screen pixel, the screen edge determiner 94 supplies, for the relevant pixel, L0 weight factor information (0) and L1 weight factor information (1) to the arithmetic operator 93. Correspondingly, in step S59, the arithmetic operator 93 performs prediction on the relevant pixel by restrictively using the L1 reference pixel.

In step S56, in the case where it is determined that the equation (7) is not established, the processing proceeds to step S60. In step S60, the screen edge determiner 94 determines whether the y coordinate yL1 of the pixel to be referenced for L1 is smaller than 0 or is equal to or larger than the height of the picture frame (height: the size of the screen in the y direction), or whether the x coordinate xL1 of the pixel to be referenced for L1 is smaller than 0 or is equal to or larger than the width of the picture frame (width: the size of the screen in the x direction.)

In other words, in step S60 also, determination is made whether or not the above-described equation (8) is established. In step S60, in the case where it is determined that the equation (8) is established, the processing proceeds to step S61.

In this case, since the pixel to be referenced for L1 is an off-screen pixel and the pixel to be referenced for L0 is an on-screen pixel, the screen edge determiner 94 supplies, for the relevant pixel, L0 weight factor information (1) and L1 weight factor information (0) to the arithmetic operator 93. Correspondingly, in step S61, the arithmetic operator 93 performs prediction on the relevant pixel by restrictively using the L0 reference pixel.

Meanwhile, in step S60, in the case where it is determined that the equation (8) is not established, which means both the pixels are on-screen pixels, the processing proceeds to step S58, and weighted prediction according to H.264/AVC standard is performed for the relevant pixel.

In step S58, S59, or S61, the resultant weighted (Bi-pred) prediction information of the weighted prediction performed at the arithmetic operator 93 is outputted to the prediction mode decider 85.

The processing as described above is summarized as shown in FIG. 16. In the example of FIG. 16, a correspondence relationship is shown between the positions of reference pixels and processing methods therefor.

Specifically, in the case where the position of the relevant reference pixel in the L0 reference region and the position of the relevant reference pixel in the L1 reference region are both on-screen, namely, where Yes in step S57 of FIG. 14, weighted prediction according to H.264/AVC standard is used as the method for processing the relevant pixel.

In the case where the position of the relevant reference pixel in the L0 reference region is off-screen and the position of the relevant reference pixel in the L1 reference region is on-screen, namely, where No in step S57 of FIG. 14, used as the method for processing the relevant pixel is weighted prediction where weight is placed on the on-screen L1 reference pixel rather than on the off-screen L0 reference pixel. In the example depicted in FIG. 14, the weight factors are 0 and 1, and thus prediction restrictively using the L1 reference pixel is used.

In the case where the position of the relevant reference pixel in the L1 reference region is off-screen and the position of the relevant reference pixel in the L0 reference region is on-screen, namely, where Yes in step S60 of FIG. 14, used as the method for processing the relevant pixel is weighted prediction where weight is placed on the on-screen L0 reference pixel rather than on the off-screen L1 reference pixel. In the example of FIG. 14, the weight factors are 0 and 1, and thus prediction restrictively using the L0 reference pixel is used.

In the case where the position of the relevant reference pixel in the L0 reference region and the position of the relevant reference pixel in the L1 reference region are both off-screen, namely, where No in step S60 of FIG. 14, weighted prediction according to H.264/AVC standard is used as the method for processing the relevant pixel.

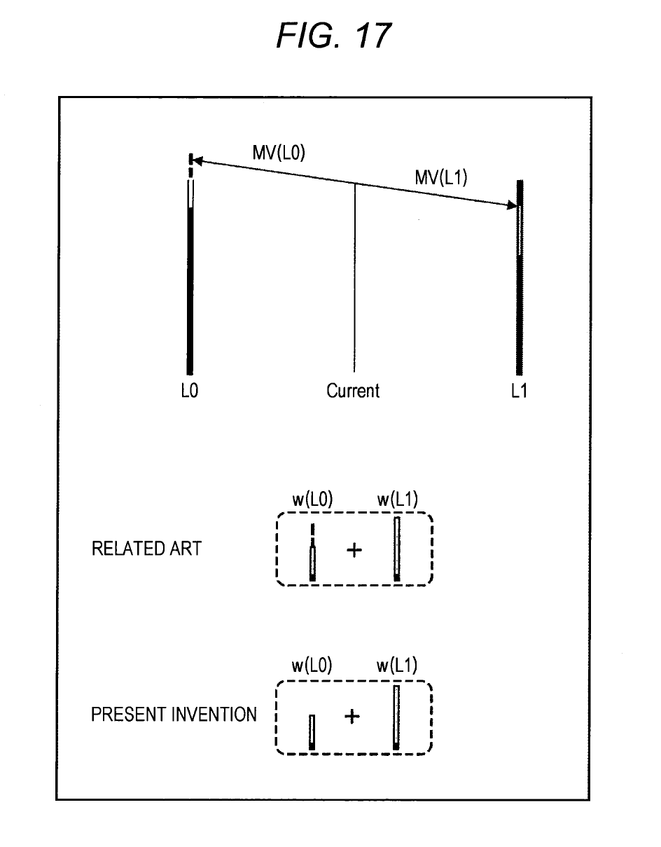

Description is given next of effects of the example of FIG. 14 with reference to FIG. 17. In the example of FIG. 17, the respective on-screen portions of an L0 reference picture, a Current picture, and an L1 reference picture are depicted sequentially from the left. The dashed portion in the L0 reference picture indicates the off-screen portion.

More specifically, the reference block in the L0 reference picture indicated by the motion vector MV (L0) that has been searched within the relevant block in the Current picture is constituted by an off-screen portion (the dashed portion) and an on-screen portion (the hollowed portion), while the reference block in the L1 reference picture indicated by the motion vector MV (L1) that has been searched within the relevant block in the Current picture is constituted by an on-screen portion (the hollowed portion.)

In other words, according to the H.264/AVC standard, both the reference blocks have been used for weighted prediction for the relevant block, which prediction uses the weight factors w (L0) and w (L1) regardless of the existence of an off-screen portion.

On the other hand, according to the present invention (especially with regard to the example of FIG. 14), weighted prediction for the relevant block that uses weight factors w (L0) and w (L1) does not use the off-screen portion in the L0 reference block. With regard to the off-screen portion in the L0 reference block, pixels for use are limited to the L1 reference block in the weighted prediction for the relevant block.

That is, since the pixels in the off-screen portion that are probably inaccurate information are not used, prediction accuracy is improved as compared with the weighted prediction according to H.264/AVC standard. Obviously, not only in the example of FIG. 14 in which the weight factors are 0 and 1 but also in the case where the weight factor for the off-screen portion is set lower than the weight factor for the on-screen portion, prediction accuracy is improved as compared with the weighted prediction according to H.264/AVC standard.

The compressed images thus encoded are transmitted through a specific channel to be decoded by an image decoding apparatus.

### Configuration Example of Image Decoding Apparatus

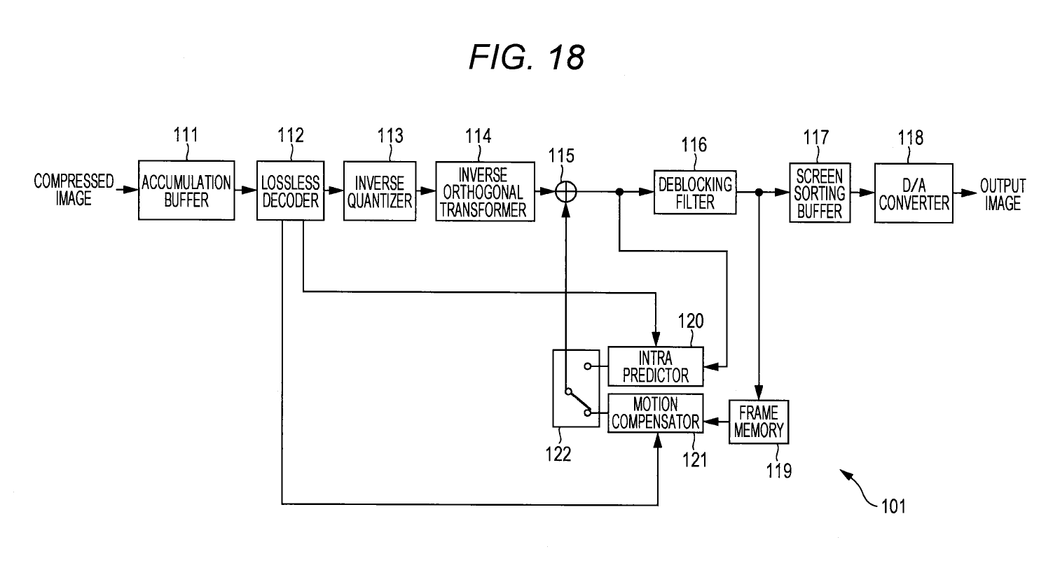

FIG. 18 depicts the configuration of one embodiment of an image decoding apparatus serving as the image processing apparatus to which the present invention is applied.

An image decoding apparatus 101 includes an accumulation buffer 111, a lossless decoder 112, an inverse quantizer 113, an inverse orthogonal transformer 114, an arithmetic operator 115, a deblocking filter 116, a screen sorting buffer 117, a D/A converter 118, a frame memory 119, an intra predictor 120, a motion compensator 121, and a switch 122.

The accumulation buffer 111 accumulates compressed images that have been transmitted thereto. The lossless decoder 112 decodes the information that has been supplied from the accumulation buffer 111 and encoded by the lossless encoder 66 of FIG. 9 according to a system corresponding to the coding system adopted by the lossless encoder 66. The inverse quantizer 113 performs inverse quantization on the images decoded by the lossless decoder 112 according to a method corresponding to the quantization method adopted by the quantizer 65 of FIG. 9. The inverse orthogonal transformer 114 performs inverse orthogonal transform on the outputs from the inverse quantizer 113 according to a method corresponding to the orthogonal transform method adopted by the orthogonal transformer 64 of FIG. 9.

The inverse orthogonal transformed outputs are added by the arithmetic operator 115 to prediction images to be supplied from the switch 122 and are decoded. The deblocking filter 116 removes block distortion in the decoded images and then supplies the images to the frame memory 119 for accumulation, while outputting the images to the screen sorting buffer 117.

The screen sorting buffer 117 sorts images. More specifically, the order of the frames that has been sorted by the screen sorting buffer 62 of FIG. 9 into the encoding order is sorted into the original display order. The D/A converter 118 performs D/A conversion on the images supplied from the screen sorting buffer 117 and outputs the images to a display (not shown), so as for the images to be displayed thereon.

The motion compensator 121 is supplied with the images to be referenced from the frame memory 119. The incoming images from the arithmetic operator 115 that are yet to be subjected to deblocking filtering are supplied to the intra predictor 120 as images for use in intra prediction.

The intra predictor 120 is supplied from the lossless decoder 112 with the information indicating an intra prediction mode that has been obtained by decoding header information. The intra predictor 120 generates prediction images based on this information and outputs the generated prediction images to the switch 122.

Of the pieces of information obtained by decoding header information, the motion compensator 121 is supplied from the lossless decoder 112 with information including inter prediction mode information, motion vector information, and reference frame information. The inter prediction mode information is received per macroblock. The motion vector information and the reference frame information are received per target block. In the case where weight factors are calculated at the image coding apparatus 51, the weight factors are also received per frame or per sequence.

The motion compensator 121 performs compensation on reference images based on the inter prediction modes from the lossless decoder 112 by using the supplied motion vector information or motion vector information obtainable from the peripheral blocks, so as to generate prediction images for blocks. At this time, as at the motion prediction compensator 75 of FIG. 9, in the case of B pictures in direct mode or in bi-predictive prediction mode, i.e. in prediction a mode where a plurality of different reference images are used, the motion compensator 121 performs weighted prediction according to whether or not the pixels to be referenced for the target blocks are off-screen in the reference images thereof, so as to generate prediction images. The generated prediction images are outputted to the arithmetic operator 115 through the switch 122.

The switch 122 selects prediction images that have been generated by the motion compensator 121 or the intra predictor 120 and supplies the images to the arithmetic operator 115.

### [Configuration Example of Motion Compensator]

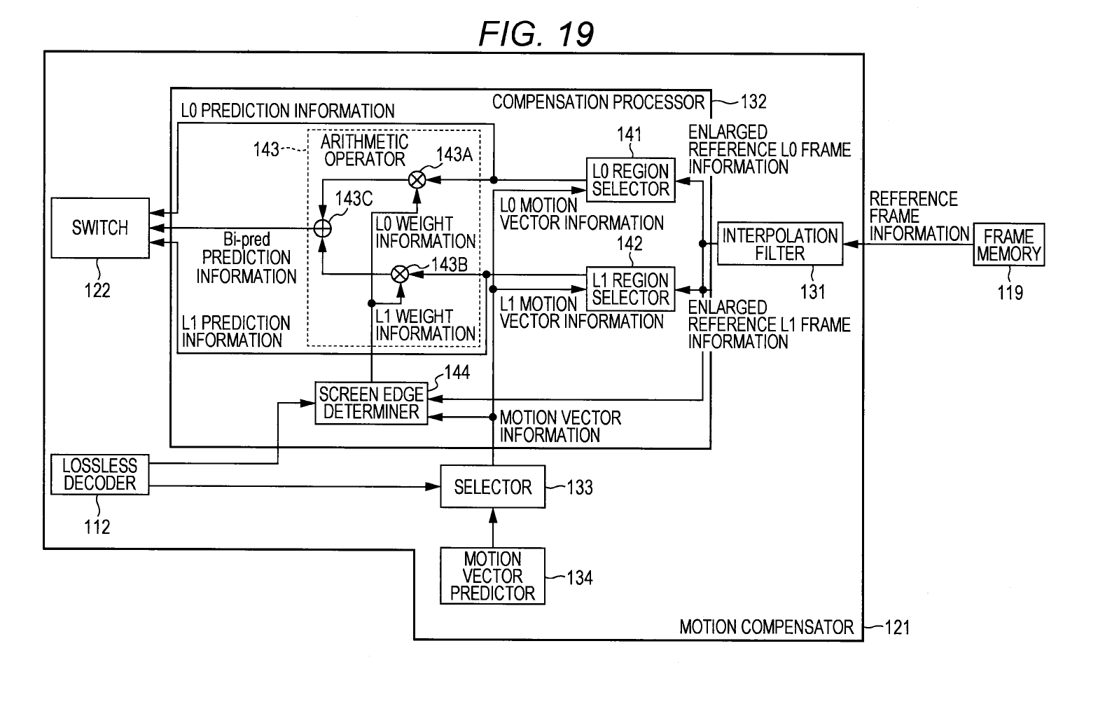

FIG. 19 is a block diagram depicting a detailed configuration example of the motion compensator 121.

In the example of FIG. 19, the motion compensator 121 includes an interpolation filter 131, a compensation processor 132, a selector 133, and a motion vector predictor 134.

The interpolation filter 131 receives reference frame (reference image) information from the frame memory 119. The interpolation filter 131 performs interpolation between the pixels of the reference frames, as at the interpolation filter 81 of FIG. 11, for vertical and lateral enlargement by four times and outputs the enlarged frame information to the compensation processor 132.

The compensation processor 132 includes an L0 region selector 141, an L1 region selector 142, an arithmetic operator 143, and a screen edge determiner 144. An example for B pictures is shown with respect to the compensation processor 132 in the example of FIG. 19.

The enlarged reference frame information from the interpolation filter 131 is inputted to the L0 region selector 141, the L1 region selector 142, and the screen edge determiner 144.

The L0 region selector 141 selects a corresponding L0 reference region from the enlarged L0 reference frame information according to prediction mode information and L0 motion vector information from the selector 133 and outputs the information to the arithmetic operator 143. The information on the reference region thus outputted is inputted to the switch 122 as L0 prediction information in the case of L0 prediction mode.

The L1 region selector 142 selects a corresponding L1 reference region from the enlarged L1 reference frame information according to prediction mode information and L1 motion vector information from the selector 133 and outputs the information to the arithmetic operator 143. The information on the reference region thus outputted is inputted to the switch 122 as L1 prediction information in the case of L1 prediction mode.

The arithmetic operator 143 includes, like the arithmetic operator 93 of FIG. 11, a multiplier 143A, a multiplier 143B, and an adder 143C. The multiplier 143A multiplies the L0 reference region information from the L0 region selector 141 by L0 weight information from the screen edge determiner 144 and outputs the result to the adder 143C. The multiplier 143B multiplies the L1 reference region information from the L1 region selector 142 by L1 weight information from the screen edge determiner 144 and outputs the result to the adder 143C. The adder 143C adds the L0 reference region and the L1 reference region that have been allocated with weights based on the L0 and L1 weight information, so as to output the result to the switch 122 as weighted prediction information (Bi-pred prediction information.)

The screen edge determiner 144 is supplied with inter prediction mode information from the lossless decoder 112, the enlarged reference frame information from the interpolation filter 131, and the motion vector information from the selector 133.

The screen edge determiner 144 determines whether or not the L0 reference pixels or the L1 reference pixels are off-screen based on the reference frame information and the motion vector information in the case of bi-predictive prediction or direct mode, so as to output weight factors to be supplied to the multiplier 143A and the multiplier 143B based on the result of determination. For example, in the case where the pixels for both L0 and L1 are on-screen or off-screen, a weight factor of W=0.5 is outputted. A smaller weight factor is given to at least the off-screen reference pixels than to the on-screen reference pixels.

Further, in the case where weight factors are calculated by the weight calculator 95 of FIG. 11, the weight factors are also supplied from the lossless decoder 112. Thus, the screen edge determiner 144 outputs the weight factors to be supplied to the multiplier 143A and the multiplier 143B based on the result of determination.

The selector 133 is also supplied with the inter prediction information from the lossless decoder 112 and motion vector information if any. The selector 133 selects either the motion vector information from the lossless decoder 112 or the motion vector information that has been found by the motion vector predictor 134 according to the prediction mode, so as to supply the selected motion vector information to the screen edge determiner 144, the L0 region selector 141, and the L1 region selector 142.

The motion vector predictor 134 predicts, like the motion vector predictor 84 of FIG. 11, motion vectors according to a mode such as skip mode and direct mode where motion vectors are not sent to the decoding side and supplies the results to the selector 133. In the example of FIG. 19, although not shown, for example, motion vector information for the peripheral blocks when needed is available from the selector 133.

### [Description of Decoding Processing at Image Decoding Apparatus]

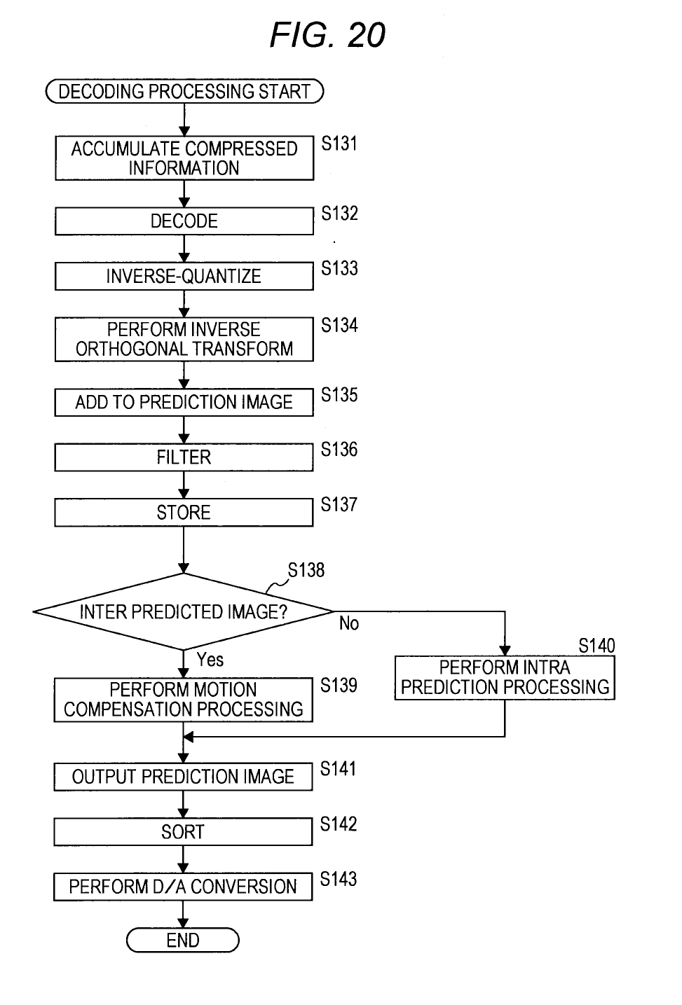

Description is given next of the decoding processing to be executed by the image decoding apparatus 101 with reference to the flowchart of FIG. 20.

In step S131, the accumulation buffer 111 accumulates images transmitted thereto. In step S132, the lossless decoder 112 decodes compressed images to be supplied from the accumulation buffer 111. Specifically, I pictures, P picture, and B pictures that have been encoded by the lossless encoder 66 of FIG. 9 are decoded.

At this time, information including motion vector information and reference frame information is also decoded per block. In addition, information including prediction mode information (information indicating intra prediction mode or inter prediction mode) is also decoded per macroblock. Moreover, in the case where weight factors are calculated at the encoding side of FIG. 9, the information thereof is also decoded.

In step S133, the inverse quantizer 113 performs inverse quantization on the transform coefficients decoded by the lossless decoder 112 with the characteristics corresponding to the characteristics of the quantizer 65 of FIG. 9. In step S134, the inverse orthogonal transformer 114 performs inverse orthogonal transform on the transform coefficients inverse-quantized by the inverse quantizer 113 with characteristics corresponding to the characteristics of the orthogonal transformer 64 of FIG. 9. This completes decoding of difference information corresponding to the inputs to the orthogonal transformer 64 of FIG. 9 (the outputs from the arithmetic operator 63.)

In step S135, the arithmetic operator 115 adds to difference information prediction images that are to be selected and inputted through the switch 122 in the process of step S141 to be described later. Original images are decoded by this processing. In step S136, the deblocking filter 116 filters the images outputted from the arithmetic operator 115. Block distortion is thus removed. In step S137, the frame memory 119 stores the filtered images.

In step S138, the lossless decoder 112 determines whether the compressed images are inter-predicted images, namely, whether the result of the lossless decoding contains information indicating an optimum inter prediction mode, based on the result of the lossless decoding of the header portions for the compressed images.

In the case where the compressed images are determined as having been inter-predicted in step S138, the lossless decoder 112 supplies information including motion vector information, reference frame information, and information indicating the optimum inter prediction mode to the motion compensator 121. In the case where weight factors are decoded, the decoded weight factors are also supplied to the motion compensator 121.

Then, in step S139, the motion compensator 121 performs motion compensation processing. The motion compensator 121 performs compensation on reference images by using the motion vector information supplied thereto or motion vector information obtainable from the peripheral blocks, based on the inter prediction mode from the lossless decoder 112, so as to generate prediction images of blocks.

At this time, like the motion prediction compensator 75 of FIG. 9, the motion compensator 121 performs weighted prediction according to whether or not the pixels to be referenced for the target block are off screen in the reference images thereof, in the case of a B picture in direct mode or bi-predictive prediction mode, namely, in a prediction mode where a plurality of different reference images are used, so as to generate a prediction image. Prediction images thus generated are outputted through the switch 122 to the arithmetic operator 115. The compensation processing for B pictures is similar to the compensation processing described with reference to FIG. 14, and the description thereof is thus not given.

Meanwhile, in the case where determination is made in step S138 that a compressed image has not been inter-predicted, namely, where the result of the lossless decoding contains information indicating an optimum intra prediction mode, the lossless decoder 112 supplies the information indicating the optimum intra prediction mode to the intra predictor 120.

Then, in step S140, the intra predictor 120 performs intra prediction processing on the images from the frame memory 119 in the optimum intra prediction mode indicated by the information from the lossless decoder 112, so as to generate intra prediction images. Then, the intra predictor 120 outputs the intra prediction images to the switch 122.

In step S141, the switch 122 selects prediction images and outputs the images to the arithmetic operator 115. Specifically, the prediction images generated by the intra predictor 120 or the prediction images generated by the motion compensator 121 are supplied. Hence, selection is made from among the supplied prediction images so as to be outputted to the arithmetic operator 115, and, as described above, the selected images are added to the outputs from the inverse orthogonal transformer 114 in step S135.

In step S142, the screen sorting buffer 117 performs sorting. More specifically, the frame order that has been sorted by the screen sorting buffer 62 of the image coding apparatus 51 for encoding is sorted into the original display order.

In step S143, the D/A converter 118 performs D/A conversion on the images from the screen sorting buffer 117. These images are outputted to a display (not shown), and the images are displayed thereon.

As described above, in the image coding apparatus 51 and the image decoding apparatus 101, in the case where an off-screen portion is to be referenced in either L0 or L1 reference pixels in bi-predictive prediction mode and direct mode where weighted prediction using a plurality of different reference pictures is performed, weighted prediction is performed such that a larger weight is placed on, rather than on the off-screen pixels that are probably inaccurate, the other pixels with higher reliability.

In other words, according to the present invention, use is made of on-screen pixels that belong to the blocks that have not been used at all in the proposal of Patent Document 1.

Hence, according to the present invention, improvement is achieved in prediction accuracy of inter coding for B pictures, especially in the vicinity of edges of screens. This allows for reduction of residual signals, and the reduction in bit amount of the residual signals attains improvement in coding efficiency.

This improvement is conspicuously seen in smaller screens of, for example, portable terminals, rather than in larger screens. In addition, the technique is further effectively used in cases of low bit rates.

Reduction of residual signals leads to decrease of coefficients thereof after the orthogonal transform, and it is expected that many coefficients become zero after quantization. According to H.264/AVC standard, the number of continuous zeros is included in stream information. Normally, the amount of codes is far less for representation by means of the number of zeros than by replacement of values other than 0 with predetermined codes; thus, many coefficients' taking zero value according to the present invention leads to reduction in bit amount of codes.

Further, according to the present invention, improvement in prediction accuracy in direct mode is achieved, so that direct mode is more easily selected. Since direct mode does not involve motion vector information, header information for motion vector information is reduced especially in the vicinity of edges of screens.

That is, according to the related art, even when selection of direct mode is desired in the case where the reference region in an L0 or L1 reference picture is off-screen, the cost function value described above is inevitably increased, which makes it difficult for direct mode to be selected.

Further, when small blocks are selected in bi-predictive prediction in order to avoid the above situation, motion vector information for the blocks increases; however, as the present invention allows for selection of larger blocks in direct mode, reduction in motion vector information is achieved. Moreover, bit strings are defined such that larger blocks take less bit lengths; therefore, facilitation of selection of larger blocks according to the present invention provides for reduction in bit amount of mode information.

At lower bit rates, quantization is performed with a large quantization parameter QP, which means prediction accuracy directly affects the image quality. Thus, improvement in prediction accuracy attains enhancement in image quality in the vicinity of edges of screens.

In the above description, in the case where an off-screen portion is referenced in either L0 or L1 reference pixels in the motion compensation for bi-predictive prediction and direct mode, weight prediction is performed such that a larger weight is place on, rather than on the off-screen pixels that are probably inaccurate information, the other pixels with higher reliability; in bi-predictive prediction, the weighted prediction may also be employed for motion search. By applying the weighted prediction of the present invention to motion search, the accuracy of motion search is enhanced, and further improvement in prediction accuracy is achievable over the case where the weighted prediction is used for motion compensation.

### [Description of Application to Extended Macroblock Size]

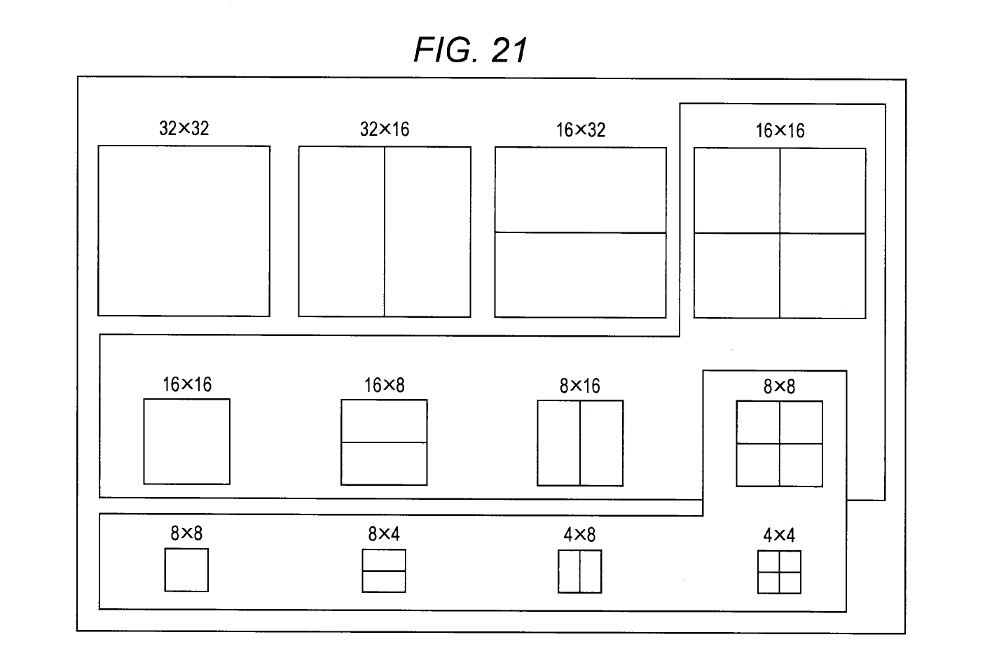

FIG. 21 depicts the exemplary block sizes proposed in Non-patent Document 2. In Non-patent Document 2, the macroblock size is extended to 32×32 pixels.

In the upper row of FIG. 21, macroblocks constituted by 32×32 pixels are sequentially depicted from the left, each macroblock being divided into the blocks (partitions) of 32×32 pixels, 32×16 pixels, 16×32 pixels, and 16×16 pixels. In the middle row of FIG. 21, blocks constituted by 16×16 pixels are sequentially depicted from the left, each block being divided into the blocks of 16×16 pixels, 16×8 pixels, 8×16 pixels, and 8×8 pixels. In the lower row of FIG. 21, blocks constituted by 8×8 pixels are sequentially depicted from the left, each block being divided into the blocks of 8×8 pixels, 8×4 pixels, 4×8 pixels, and 4×4 pixels.

In other words, the macroblock of 32×32 pixels is processable in the blocks of 32×32 pixels, 32×16 pixels, 16×32 pixels, and 16×16 pixels that are depicted in the upper row of FIG. 21.

The 16×16 pixel block depicted on the right of the upper row is processable, as in the case of H.264/AVC standard, in the blocks of 16×16 pixels, 16×8 pixels, 8×16 pixels, and 8×8 pixels that are depicted in the middle row.

The 8×8 pixel block depicted on the right of the middle row is processable, as in the case of H.264/AVC standard, in the blocks of 8×8 pixels, 8×4 pixels, 4×8 pixels, and 4×4 pixels that are depicted in the lower row.

According to the proposal of Non-patent Document 2, adopting of such a hierarchical structure ensures scalability with H.264/AVC standard for 16×16 pixel blocks or smaller, while defining larger blocks as supersets thereof.

The present invention is applicable to such extended macroblock sizes thus proposed.

In the foregoing description, H.264/AVC standard is basically used as the coding standard; however, the present invention is not limited thereto and is applicable to image coding apparatuses/image decoding apparatuses using other coding standards/decoding standards for performing motion prediction and compensation processing.

It is to be noted that the present invention is applicable to image coding apparatuses and image decoding apparatuses for use in receiving image information (bitstreams) that is compressed by orthogonal transform, such as discrete cosine transform, and motion compensation, through network media, such as satellite broadcasting, cable television, the Internet, or mobile phones, according to, for example, MPEG and H.26x. Further, the present invention is applicable to image coding apparatuses and image decoding apparatuses for use in performing processing on storage media such as optical disks, magnetic disks, and flash memories. Moreover, the present invention is applicable to motion prediction compensating apparatuses included in those image coding apparatuses and image decoding apparatuses.

The series of processes described above are executable either by hardware or software. In the case of executing the series of processes by software, programs configuring the software are installed on a computer. Herein, exemplary computers include computers that are built in dedicated hardware and general-purpose personal computers configured to execute various functions on installation of various programs.

### [Configuration Example of Personal Computer]

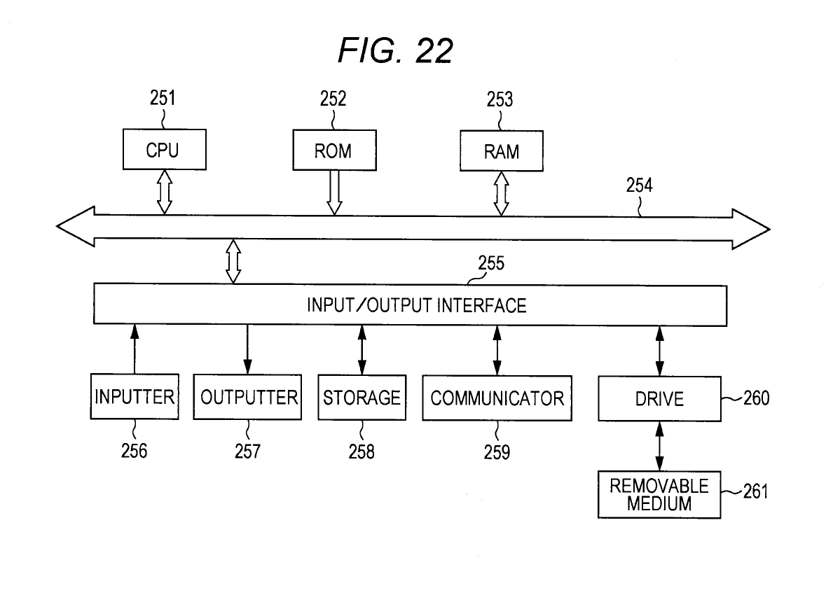

FIG. 22 is a block diagram depicting a configuration example of the hardware of a computer for executing the above-described series of processes based on a program.

In the computer, a CPU (Central Processing Unit) 251, a ROM (Read Only Memory) 252, and a RAM (Random Access Memory) 253 are coupled to one another by a bus 254.

The bus 254 is further connected with an input/output interface 255. To the input/output interface 255 are connected with an inputter 256, an outputter 257, a storage 258, a communicator 259, and a drive 260.

The inputter 256 includes a keyboard, a mouse, and a microphone. The outputter 257 includes a display and a speaker. The storage 258 includes a hard disk and a nonvolatile memory. The communicator 259 includes a network interface. The drive 260 drives a removable medium 261 such as a magnetic disk, an optical disk, a magnetoptical disk, or a semiconductor memory.

In the computer thus configured, the CPU 251 executes a program that is stored on, for example, the storage 258 by having the program loaded on the RAM 253 through the input/output interface 255 and the bus 254, such that the above-described series of processes is performed.

The program to be executed by the computer (CPU 251) may be provided in the form of the removable medium 261 as, for example, a package medium recording the program. The program may also be provided through a wired or radio transmission medium such as Local Area Network, the Internet, or digital broadcasting.

In the computer, the program may be installed on the storage 258 through the input/output interface 255 with the removable medium 261 attached to the drive 260. The program may also be received through a wired or radio transmission medium at the communicator 259 for installation on the storage 258. Otherwise, the program may be installed on the ROM 252 or the storage 258 in advance.

The program to be executed by the computer may be a program by which the processes are performed in time sequence according to the order described herein, or alternatively, may be a program by which processes are performed at an appropriately timing, e.g., in parallel or when a call is made.

Embodiments of the present invention are not limited to the foregoing embodiments, and various changes and modifications can be made without departing from the scope of the present invention.

For example, the above-described image coding apparatus 51 and the image decoding apparatus 101 are applicable to any electronics. Examples thereof are described hereinafter.

### [Configuration Example of Television Receiver]

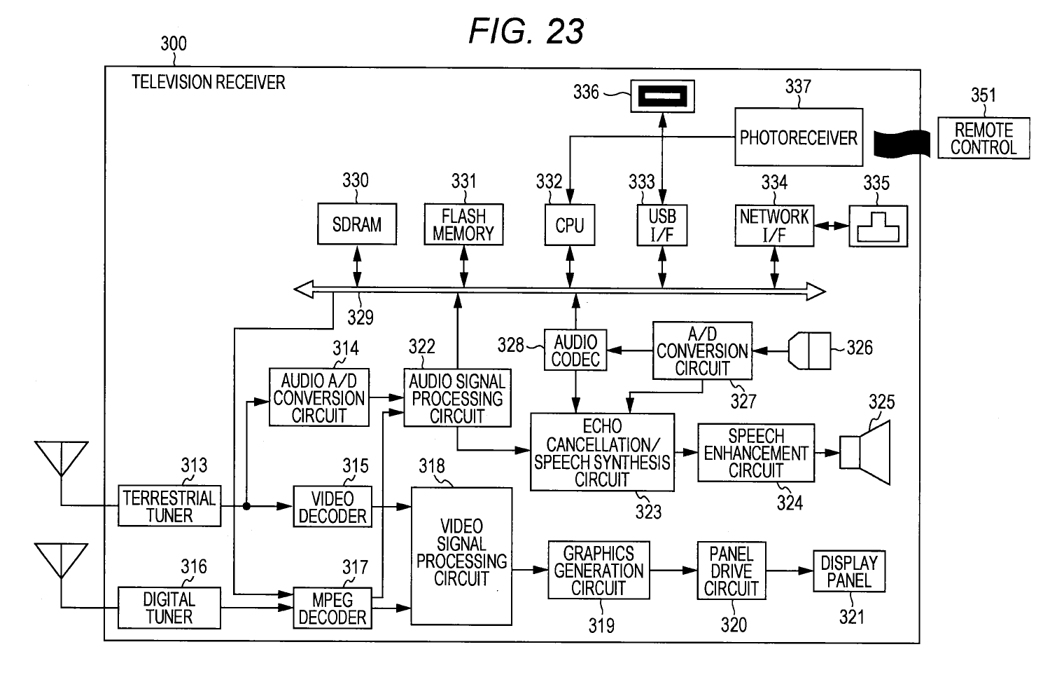

FIG. 23 is a block diagram depicting a main configuration example of a television receiver using an image decoding apparatus to which the present invention is applied.

A television receiver 300 depicted in FIG. 23 includes a terrestrial tuner 313, a video decoder 315, a video signal processing circuit 318, a graphics generation circuit 319, a panel drive circuit 320, and a display panel 321.

The terrestrial tuner 313 receives broadcast wave signals for terrestrial analog broadcasting through an antenna, demodulates them to obtain video signals, and supplies the signals to the video decoder 315. The video decoder 315 performs decoding processing on the video signals supplied from the terrestrial tuner 313 and supplies the resultant digital component signals to the video signal processing circuit 318.

The video signal processing circuit 318 performs predetermined processing such as noise reduction on the video data supplied from the video decoder 315 and supplies the resultant video data to the graphics generation circuit 319.

The graphics generation circuit 319 generates, for example, video data for broadcasts to be displayed on the display panel 321 and image data obtainable upon processing based on an application to be supplied over a network, so as to supply the generated video data and image data to the panel drive circuit 320. In addition, the graphics generation circuit 319 appropriately performs processing, such as generating video data (graphics) to be used for displaying a screen for use by a user upon selection of an item and supplying to the panel drive circuit 320 video data obtainable, for example, through superimposition on the video data of a broadcast.

The panel drive circuit 320 drives the display panel 321 based on the data supplied from the graphics generation circuit 319 and causes the display panel 321 to display thereon video of broadcasts and various screens as described above.

The display panel 321 includes an LCD (Liquid Crystal Display) and is adapted to display video of broadcasts under the control of the panel drive circuit 320.

Further, the television receiver 300 also includes an audio A/D (Analog/Digital) conversion circuit 314, an audio signal processing circuit 322, an echo cancellation/speech synthesis circuit 323, a speech enhancement circuit 324, and a speaker 325.

The terrestrial tuner 313 demodulates the received broadcast wave signals so as to obtain not only video signals but also audio signals. The terrestrial tuner 313 supplies the obtained audio signals to the audio A/D conversion circuit 314.

The audio A/D conversion circuit 314 performs A/D conversion processing on the audio signals supplied from the terrestrial tuner 313 and supplies the resultant digital audio signals to the audio signal processing circuit 322.

The audio signal processing circuit 322 performs predetermined processing such as noise reduction on the audio data supplied from the audio A/D conversion circuit 314 and supplies the resultant audio data to the echo cancellation/speech synthesis circuit 323.

The echo cancellation/speech synthesis circuit 323 supplies the audio data supplied from the audio signal processing circuit 322 to the speech enhancement circuit 324.

The speech enhancement circuit 324 performs D/A conversion processing and amplification processing on the audio data supplied from the echo cancellation/speech synthesis circuit 323 and then makes adjustment to a specific sound volume, so as to cause the speaker 325 to output the audio.

Further, the television receiver 300 includes a digital tuner 316 and an MPEG decoder 317.

The digital tuner 316 receives broadcast wave signals for digital broadcasting (terrestrial digital broadcasting and BS (Broadcasting Satellite)/CS (Communications Satellite) digital broadcasting) through an antenna, demodulates the signals, and obtains MPEG-TSs (Moving Picture Experts Group-Transport Streams), for supply to the MPEG decoder 317.

The MPEG decoder 317 performs unscrambling on the MPEG-TSs supplied from the digital tuner 316, so as to extract a stream containing data of a broadcast to be played (viewed.) The MPEG decoder 317 decodes audio packets constructing the extracted stream and supplies the resultant audio data to the audio signal processing circuit 322, while decoding video packets constructing the stream to supply the resultant video data to the video signal processing circuit 318. Further, the MPEG decoder 317 supplies EPG (Electronic Program Guide) data extracted from the MPEG-TSs through a path (not shown) to the CPU 332.

The television receiver 300 thus uses the above-described image decoding apparatus 101 in the form of the MPEG decoder 317 for decoding video packets. Hence, the MPEG decoder 317 allows for, as in the case of the image decoding apparatus 101, improvement in prediction accuracy for B pictures, especially in the vicinity of edges of screens. In this manner, improvement in coding efficiency is achievable.

The video data supplied from the MPEG decoder 317 is, as in the case of the video data supplied from the video decoder 315, is subjected to predetermined processing at the video signal processing circuit 318. Then, the video data performed with the predetermined processing is appropriately superimposed at the graphics generation circuit 319 with, for example, video data generated, and is supplied through the panel drive circuit 320 to the display panel 321, such that the images are displayed thereon.

The audio data supplied from the MPEG decoder 317 is, as in the case of the audio data supplied from the audio A/D conversion circuit 314, subjected to predetermined processing at the audio signal processing circuit 322. Then, the audio data performed with the predetermined processing is supplied through the echo cancellation/speech synthesis circuit 323 to the speech enhancement circuit 324 to be subjected to D/A conversion processing and amplification processing. As a result, audio adjusted to a specific sound volume is outputted from the speaker 325.

The television receiver 300 also includes a microphone 326 and an A/D conversion circuit 327.

The A/D conversion circuit 327 receives speech signals of users to be taken by the microphone 326 that is provided in the television receiver 300 for use in speech conversation. The A/D conversion circuit 327 performs A/D conversion processing on the speech signals received and supplies the resultant digital speech data to the echo cancellation/speech synthesis circuit 323.

The echo cancellation/speech synthesis circuit 323 performs, in the case where speech data of a user (a user A) of the television receiver 300 is supplied from the A/D conversion circuit 327, echo cancellation on the speech data of the user A. Then, the echo cancellation/speech synthesis circuit 323 causes the speaker 325, through the speech enhancement circuit 324, to output the speech data that results from echo cancellation followed by, for example, synthesis with other speech data.

The television receiver 300 further includes an audio codec 328, an internal bus 329, an SDRAM (Synchronous Dynamic Random Access Memory) 330, a flash memory 331, a CPU 332, a USB (Universal Serial Bus) I/F 333, and a network I/F 334.

The A/D conversion circuit 327 receives speech signals of users taken by the microphone 326 that is provided in the television receiver 300 for use in speech conversation. The A/D conversion circuit 327 performs A/D conversion processing on the speech signals received and supplies the resultant digital speech data to the audio codec 328.

The audio codec 328 converts the speech data supplied from the A/D conversion circuit 327 into data in a predetermined format for transmission via a network and supplies the data through the internal bus 329 to the network I/F 334.

The network I/F 334 is connected to a network by means of a cable attached to a network terminal 335. The network I/F 334 transmits the speech data supplied from the audio codec 328 to, for example, another apparatus to be connected to the network. Further, the network I/F 334 receives through the network terminal 335 speech data to be transmitted from, for example, another apparatus to be connected through the network, so as to supply the data through the internal bus 329 to the audio codec 328.

The audio codec 328 converts the speech data supplied from the network I/F 334 into data in a predetermined format and supplies the data to the echo cancellation/speech synthesis circuit 323.

The echo cancellation/speech synthesis circuit 323 performs echo cancellation on the speech data to be supplied from the audio codec 328 and causes, through the speech enhancement circuit 324, the speaker 325 to output the speech data that results from, for example, synthesis with other speech data.

The SDRAM 330 stores various kinds of data to be used by the CPU 332 for processing.

The flash memory 331 stores programs to be executed by the CPU 332. The programs stored on the flash memory 331 are read by the CPU 332 at a specific timing such as upon boot of the television receiver 300. The flash memory 331 also stores data including EPG data that has been obtained via digital broadcasting and data that has been obtained from a specific server over a network.

For example, stored on the flash memory 331 is MPEG-TSs containing content data obtained from a specific server over a network under the control of the CPU 332. The flash memory 331 supplies the MPEG-TSs through the internal bus 329 to the MPEG decoder 317, for example, under the control of the CPU 332.

The MPEG decoder 317 processes, as in the case of the MPEG-TSs supplied from the digital tuner 316, the MPEG-TSs. In this manner, the television receiver 300 is configured to receive content data including video, audio, and other information, over networks, to perform decoding by using the MPEG decoder 317, and to provide the video for display or the audio for output.

The television receiver 300 further includes a photoreceiver 337 for receiving infrared signals to be transmitted from a remote control 351.

The photoreceiver 337 receives infrared signals from the remote control 351 and outputs to the CPU 332 control codes indicating the content of the user operation that has been obtained through demodulation.

The CPU 332 executes programs stored on the flash memory 331 and conducts control over the overall operation of the television receiver 300 according to, for example, the control codes to be supplied from the photoreceiver 337. The CPU 332 and the constituent portions of the television receiver 300 are connected through paths (not shown.)

The USB I/F 333 performs data transmission/reception with an external instrument of the television receiver 300, the instrument to be connected by means of a USB cable attached to a USB terminal 336. The network I/F 334 is connected to a network by means of a cable attached to the network terminal 335 and is adapted to perform transmission/reception of data other than audio data with various apparatuses to be connected to the network.

The television receiver 300 allows for improvement in coding efficiency by the use of the image decoding apparatus 101 in the form of the MPEG decoder 317. As a result, the television receiver 300 is capable of obtaining and rendering finer decoded images based on broadcast wave signals receivable through an antenna and content data obtainable over networks.

### [Configuration Example of Mobile Phone]

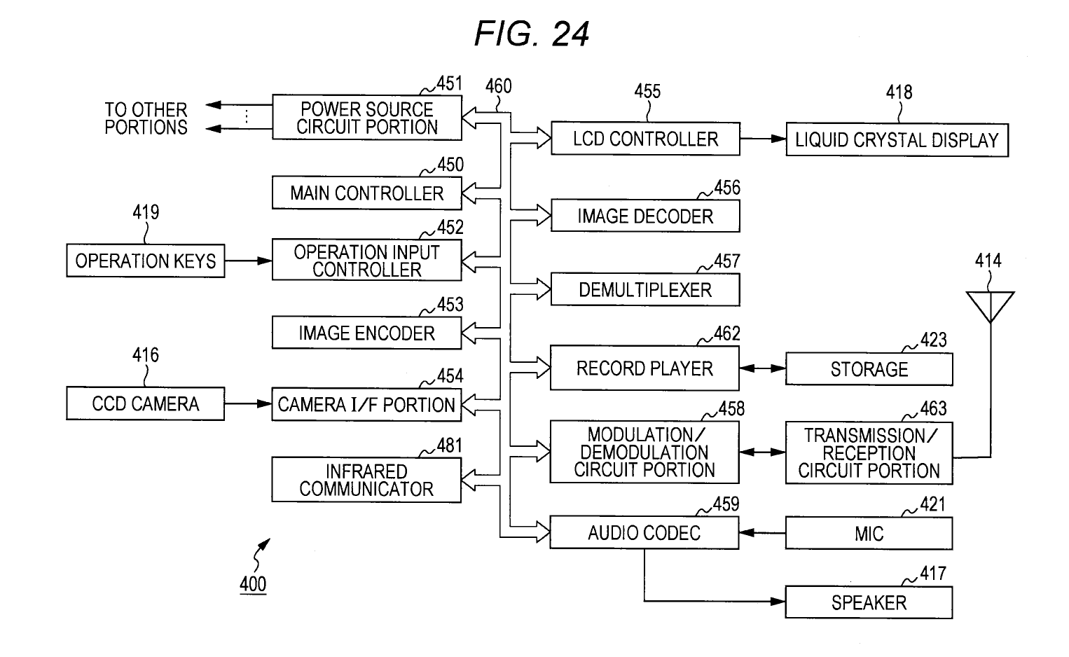

FIG. 24 is a block diagram depicting a main configuration example of a mobile phone using an image coding apparatus and an image decoding apparatus to which the present invention is applied.

A mobile phone 400 depicted in FIG. 24 includes a main controller 450 that is configured to perform overall control over the constituent portions, a power source circuit portion 451, an operation input controller 452, an image encoder 453, a camera I/F portion 454, an LCD controller 455, an image decoder 456, a demultiplexer 457, a record player 462, a modulation/demodulation circuit portion 458, and an audio codec 459. These portions are coupled to one another by a bus 460.

The mobile phone 400 also includes operation keys 419, a CCD (Charge Coupled Devices) camera 416, a liquid crystal display 418, a storage 423, a transmission/reception circuit portion 463, an antenna 414, a microphone (mic) 421, and a speaker 417.

The power source circuit portion 451 supplies power to the constituent portions from a battery pack when a call-end-and-power-on key is switched on by a user operation, so as to activate the mobile phone 400 into an operable condition.

The mobile phone 400 performs various operations including transmission/reception of speech signals, transmission/reception of emails and image data, image photographing, and data recording in various modes, such as a voice call mode and a data communication mode, under the control of the main controller 450 configured by, for example, a CPU, a ROM, and a RAM.

For example, in the voice call mode, the mobile phone 400 converts speech signals collected by the microphone (mic) 421 to digital speech data by the audio codec 459 and performs spread spectrum processing at the modulation/demodulation circuit portion 458, for digital/analog conversion processing and frequency conversion processing at the transmission/reception circuit portion 463. The mobile phone 400 transmits the transmitting signals obtained by the conversion processing, through the antenna 414 to a base station (not shown.) The transmitting signals (speech signals) transmitted to the base station are supplied over a public telecommunication line to a mobile phone of a call recipient.

Also, for example, in the voice call mode, the mobile phone 400 amplifies at the transmission/reception circuit portion 463 the reception signals that have been received through the antenna 414, further performs frequency conversion processing and analog/digital conversion processing, performs spread spectrum processing at the modulation/demodulation circuit portion 458, and converts the signals to analog speech signals by the audio codec 459. The mobile phone 400 outputs from the speaker 417 the analog speech signals thus obtained through the conversion.

Further, for example, in the case of transmitting emails in the data communication mode, the mobile phone 400 receives, at the operation input controller 452, text data of an email that has been inputted through operation on the operation keys 419. The mobile phone 400 processes the text data at the main controller 450 so as to cause through LCD controller 455 the liquid crystal display 418 to display the data as images.

The mobile phone 400 also generates at the main controller 450 email data based on, for example, the text data and the user instruction received at the operation input controller 452. The mobile phone 400 performs spread spectrum processing on the email data at the modulation/demodulation circuit portion 458 and performs digital/analog conversion processing and frequency conversion processing at the transmission/reception circuit portion 463. The mobile phone 400 transmits the transmitting signals that result from the conversion processing, through the antenna 414 to a base station (not shown.) The transmitting signals (emails) that have been transmitted to the base station are supplied to prescribed addresses, for example, over networks and through mail servers.

For example, in the case of receiving emails in the data communication mode, the mobile phone 400 receives through the antenna 414 at the transmission/reception circuit portion 463 signals that have been transmitted from the base station, amplifies the signals, and further performs frequency conversion processing and analog/digital conversion processing. The mobile phone 400 restores original email data through inverse spread spectrum processing at the modulation/demodulation circuit portion 458. The mobile phone 400 causes through the LCD controller 455 the liquid crystal display 418 to display the restored email data.

It is to be noted that the mobile phone 400 may cause through the record player 462 the storage 423 to record (store) the received email data.

The storage 423 is a rewritable storage medium in any form. The storage 423 may, for example, a semiconductor memory such as a RAM or a built-in flash memory, a hard disk, or a removable medium such as a magnetic disk, a magnetoptical disk, an optical disk, a USB memory, or a memory card. Apparently, other storage media may appropriately used.

Further, for example, in the case of transmitting image data in the data communication mode, the mobile phone 400 generates image data by photographing with the CCD camera 416. The CCD camera 416 has an optical device such as a lens and a diaphragm and a CCD serving as a photoelectric conversion device and is adapted to photograph a subject, to convert the intensity of the received light to electrical signals, and to generate image data of an image of the subject. The image data is compressed and encoded through the camera I/F portion 454 at the image encoder 453 according to a predetermined coding standard such as MPEG 2 or MPEG 4, so as to convert the data into encoded image data.

The mobile phone 400 uses the above-described image coding apparatus 51 in the form of the image encoder 453 for performing such processing. Hence, the image encoder 453 achieves, as in the case of the image coding apparatus 51, improvement in prediction accuracy for B pictures, especially in the vicinity of edges of the screens. Improvement in coding efficiency is thus achievable.

The mobile phone 400 performs, at the audio codec 459, analog/digital conversion on the speech collected by the microphone (mic) 421 simultaneously with photographing by the CCD camera 416 and further performs encoding thereon.

The mobile phone 400 multiplexes at the demultiplexer 457 the encoded image data supplied from the image encoder 453 and the digital speech data supplied from the audio codec 459 according to a predetermined standard. The mobile phone 400 performs spread spectrum processing on the resultant multiplexed data at the modulation/demodulation circuit portion 458 and then subjects the data to digital/analog conversion processing and frequency conversion processing at the transmission/reception circuit portion 463. The mobile phone 400 transmits the transmitting signals that result from the conversion processing, through the antenna 414 to a base station (not shown.) The transmitting signals (image data) that have been transmitted to the base station are supplied to a call recipient over, for example, a network.

In the case where the image data is not transmitted, the mobile phone 400 may cause not through the image encoder 453 but through the LCD controller 455 the liquid crystal display 418 to display the image data generated at the CCD camera 416.

Further, for example, in the case of receiving data of dynamic picture files that are linked to, for example, a simplified website in the data communication mode, the mobile phone 400 receives at the transmission/reception circuit portion 463 through the antenna 414 signals transmitted from the base station, amplifies the signals, and further performs frequency conversion processing and analog/digital conversion processing. The mobile phone 400 performs inverse spread spectrum processing on the received signals at the modulation/demodulation circuit portion 458 to restore the original multiplexed data. The mobile phone 400 separates the multiplexed data at the demultiplexer 457 to split the data into encoded image data and speech data.

The mobile phone 400 decodes at the image decoder 456 the encoded image data according to a decoding standard corresponding to a predetermined coding standard such as MPEG 2 or MPEG 4 to generate the dynamic picture data to be replayed, and causes, through the LCD controller 455, the liquid crystal display 418 to display the data thereon. In this manner, for example, moving picture data contained in dynamic picture files linked to a simplified website is displayed on the liquid crystal display 418.

The mobile phone 400 uses the above-described image decoding apparatus 101 in the form of the image decoder 456 for performing such processing. Hence, the image decoder 456 achieves, as in the case of the image decoding apparatus 101, improvement in prediction accuracy for B pictures, especially in the vicinity of edges of screens. Improvement in coding efficiency is thus achievable.

At this time, the mobile phone 400 converts digital audio data to analog audio signals at the audio codec 459 and causes the speaker 417 to output the signals. Thus, for example, audio data contained in dynamic picture files that are linked to a simplified website is replayed.

It is to be noted that, as in the case of emails, the mobile phone 400 may cause through the record player 462 the storage 423 to record (store) the received data that is linked to, for example, simplified websites.

The mobile phone 400 may also analyze, at the main controller 450, binary codes that have been obtained at the CCD camera 416 by photographing and obtain the information that is recorded in the binary codes.

Further, the mobile phone 400 may perform infrared communication with an external device at an infrared communicator 481.

The mobile phone 400 uses the image coding apparatus 51 in the form of the image encoder 453, so that improvement in prediction accuracy is achieved. As a result, the mobile phone 400 is capable of providing encoded data (image data) with good coding efficiency to other apparatuses.

And besides, the mobile phone 400 uses the image decoding apparatus 101 in the form of the image decoder 456, so that improvement in prediction accuracy is achieved. As a result, the mobile phone 400 is capable of obtaining and displaying finer decoded images from, for example, dynamic picture files that are linked to simplified websites.

In the foregoing description, the mobile phone 400 uses the CCD camera 416; instead of the CCD camera 416, an image sensor using a CMOS (Complementary Metal Oxide Semiconductor) (CMOS image sensor) may also be used. In this case also, the mobile phone 400 is capable of, as in the case of using the CCD camera 416, photographing a subject and generating image data of the images of the subject.

In the foregoing description, the mobile phone 400 is exemplarily illustrated; however, the image coding apparatus 51 and the image decoding apparatus 101 are applicable as in the case of the mobile phone 400 to any apparatus that has a photographing function and/or communication function similar to those of the mobile phone 300, such as PDAs (Personal Digital Assistants), smart phones, UMPCs (Ultra Mobile Personal Computers), netbooks, and laptop personal computers.

### [Configuration Example of Hard Disk Recorder]

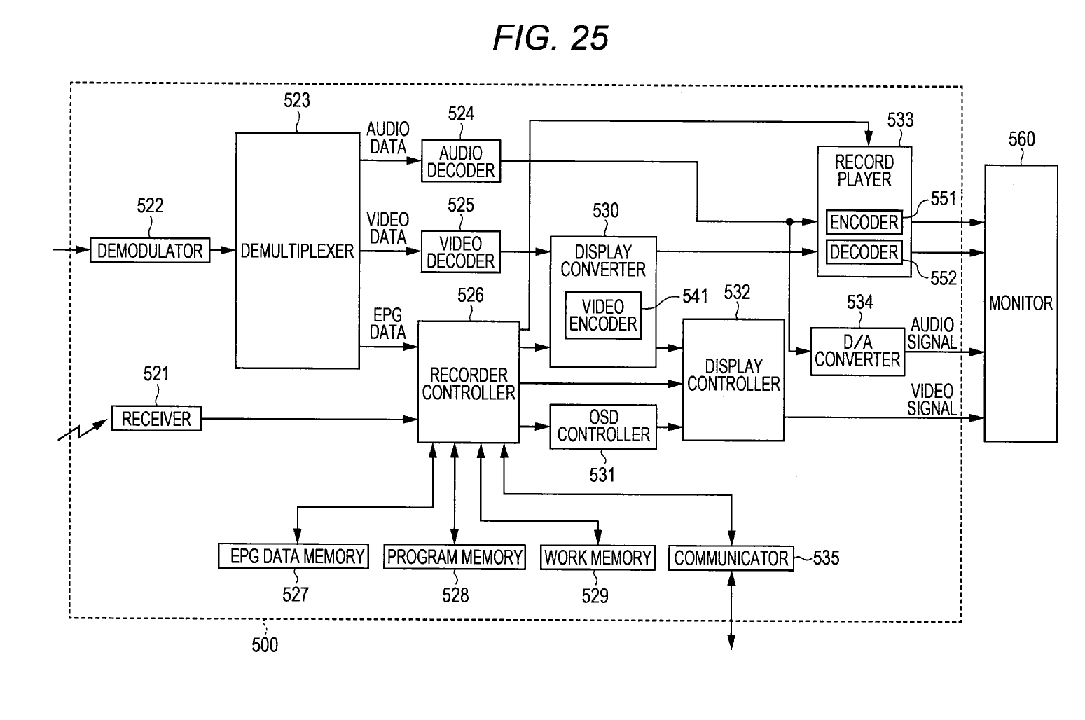

FIG. 25 is a block diagram depicting a main configuration example of a hard disk recorder using an image coding apparatus and an image decoding apparatus to which the present invention is applied.

A hard disk recorder (HDD recorder) 500 depicted in FIG. 25 is an apparatus for holding on a build-in hard disk audio data and video data of broadcasts contained in broadcast wave signals (television signals) to be transmitted from, for example, satellites or through terrestrial antennas and received from a tuner, so as to provide the held data to users at a timing in response to use instructions.

For example, the hard disk recorder 500 is configured to extract audio data and video data from broadcast wave signals and to decode the data suitably for storage on the built-in hard disk. The hard disk recorder 500 may also obtain audio data and video data from another apparatus over, for example, a network and decode the data suitably for storage on the built-in hard disk.

Further, for example, the hard disk recorder 500 is configured to decode audio data and/or video data that has been recorded on the built-in hard disk and to supply the decoded data to a monitor 560, so as to cause the monitor 560 to display the images on the screen thereof. In addition, the hard disk recorder 500 is configured to output the audio from a speaker of the monitor 560.

For example, the hard disk recorder 500 decodes audio data and video data extracted from broadcast wave signals obtained through a tuner, or audio data and video data obtained from another apparatus over a network and supplies the decoded data to the monitor 560, so as to cause the monitor 560 to display the images on the screen thereof. The hard disk recorder 500 may also cause a speaker of the monitor 560 to output the audio.

Apparently, other operations are also possible.

As depicted in FIG. 25, the hard disk recorder 500 includes a receiver 521, a demodulator 522, a demultiplexer 523, an audio decoder 524, a video decoder 525, and a recorder controller 526. The hard disk recorder 500 further includes an EPG data memory 527, a program memory 528, a work memory 529, a display converter 530, and an OSD (On Screen Display) controller 531, a display controller 532, a record player 533, a D/A converter 534, and a communicator 535.

In addition, the display converter 530 includes a video encoder 541. The record player 533 includes an encoder 551 and a decoder 552.

The receiver 521 receives infrared signals from a remote control (not shown) and converts the signals to electrical signals, so as to output the signals to the recorder controller 526. The recorder controller 526 is configured by, for example, a microprocessor and is adapted to execute various processes according to programs stored on the program memory 528. At this time, the recorder controller 526 uses the work memory 529 when needed.

The communicator 535 is connected to a network to perform communication with another apparatus over the network. For example, the communicator 535 communicates, under the control of the recorder controller 526, with a tuner (not shown), so as to output channel selection control signals mainly to the tuner.

The demodulator 522 demodulates signals supplied from the tuner and outputs the signals to the demultiplexer 523. The demultiplexer 523 separates the data supplied from the demodulator 522 into audio data, video data, and EPG data and outputs the pieces of data to the audio decoder 524, the video decoder 525, and/or the recorder controller 526, respectively.

The audio decoder 524 decodes the inputted audio data according to, for example, an MPEG standard and outputs the data to the record player 533. The video decoder 525 decodes the inputted video data according to, for example, an MPEG standard and outputs the data to the display converter 530. The recorder controller 526 supplies the inputted EPG data to the EPG data memory 527 and to have the memory store the data.

The display converter 530 encodes video data supplied from the video decoder 525 or the recorder controller 526 by using the video encoder 541 into video data according to, for example, an NTSC (National Television Standards Committee) standard and outputs the data to the record player 533. The display converter 530 also converts the size of the screen of video data to be supplied from the video decoder 525 or the recorder controller 526 into a size corresponding to the size of the monitor 560. The display converter 530 converts the video data with converted screen size further to video data according to an NTSC standard by using the video encoder 541 and converts the data into analog signals, so as to output the signals to the display controller 532.

The display controller 532 superimposes, under the control of the recorder controller 526, OSD signals outputted from the OSD (On Screen Display) controller 531 on video signals inputted from the display converter 530, so as to output the signals to the display of the monitor 560 for display.

The monitor 560 is also configured to be supplied with audio data that has been outputted from the audio decoder 524 and then been converted by the D/A converter 534 to analog signals. The monitor 560 outputs the audio signals from a built-in speaker.

The record player 533 includes a hard disk as a storage medium for recording data including video data and audio data.

For example, the record player 533 encodes audio data to be supplied from the audio decoder 524 according to an MPEG standard by using the encoder 551. The record player 533 also encodes video data to be supplied from the video encoder 541 of the display converter 530 according to an MPEG standard by using the encoder 551. The record player 533 synthesizes the encoded data of the audio data and the encoded data of the video data by means of a multiplexer. The record player 533 subjects the synthesized data to channel coding for amplification and writes the data on the hard disk by using a record head.

The record player 533 replays the data recorded on the hard disk by using a playhead, amplifies the data, and separates the data into audio data and video data by means of a demultiplexer. The record player 533 decodes the audio data and the video data by using the decoder 552 according to an MPEG standard. The record player 533 performs D/A conversion on the decoded audio data and outputs the data to the speaker of the monitor 560. The record player 533 also performs D/A conversion on the decoded video data and outputs the data to the display of the monitor 560.

The recorder controller 526 reads the latest EPG data from the EPG data memory 527 in response to a user instruction that is indicated by infrared signals to be received through the receiver 521 from the remote control and supplies the data to the OSD controller 531. The OSD controller 531 generates image data corresponding to the inputted EPG data and outputs the data to the display controller 532. The display controller 532 outputs the video data inputted from the OSD controller 531 to the display of the monitor 560 for display. In this manner, an EPG (electronic program guide) is displayed on the display of the monitor 560.

The hard disk recorder 500 may also obtain various kinds of data, such as video data, audio data, or EPG data, to be supplied from other apparatuses over a network, such as the Internet.

The communicator 535 obtains the encoded data of, for example, video data, audio data, and EPG data to be transmitted from other apparatuses over a network under to control of the recorder controller 526 and supplies the data to the recorder controller 526. For example, the recorder controller 526 supplies the obtained encoded data of video data and audio data to the record player 533 to cause the hard disk to store the data thereon. At this time, the recorder controller 526 and the record player 533 may also perform processing such as re-encoding as needed.

The recorder controller 526 decodes the obtained encoded data of video data and audio data and supplies the resultant video data to the display converter 530. The display converter 530 processes, in the same manner with respect to the video data to be supplied from the video decoder 525, the video data supplied from the recorder controller 526 and supplies the data through the display controller 532 to the monitor 560, so as to have the images displayed thereon.

Further, it may be so configured that, in addition to the image display, the recorder controller 526 supplies the decoded audio data through the D/A converter 534 to the monitor 560 and causes the audio to be outputted from the speaker.

Further, the recorder controller 526 decodes the obtained encoded data of EPG data, and supplies the decoded EPG data to the EPG data memory 527.

The hard disk recorder 500 as described above uses the image decoding apparatus 101 in the form of the video decoder 525, the decoder 552, and a decoder built in the recorder controller 526. Hence, the video decoder 525, the decoder 552, and the decoder built in the recorder controller 526 achieve, as in the case of the image decoding apparatus 101, improvement in prediction accuracy for B pictures, especially in the vicinity of edges of screens, which thus allows for improvement in coding efficiency.

Hence, the hard disk recorder 500 is capable of generating more precise prediction images. As a result, the hard disk recorder 500 is capable of, for example, obtaining finer decoded images from the encoded data of video data received through a tuner, the encoded data of video data read from a hard disk of the record player 533, and the encoded data of video data obtained over a network, such that the images are displayed on the monitor 560.

Moreover, the hard disk recorder 500 uses the image coding apparatus 51 in the form of the encoder 551. Hence, the encoder 551 achieves, as in the case of the image coding apparatus 51, improvement in prediction accuracy for B pictures, especially in the vicinity of edges of screens, thus allowing for improvement in coding efficiency.

Hence, the hard disk recorder 500 allows for improvement in coding efficiency of encoded data to be recorded on hard disks. As a result, the hard disk recorder 500 enables use of storage areas of hard disks at a higher rate and efficiency.

In the foregoing, description is given of a case of the hard disk recorder 500 for recoding video data and audio data on a hard disk; however, the recording medium may obviously take any form. For example, the image coding apparatus 51 and the image decoding apparatus 101 are applicable to, as in the case of the above-described hard disk recorder 500, recorders using recording media other than hard disks, such as flash memories, optical disks, or video tapes.

### [Configuration Example of Camera]

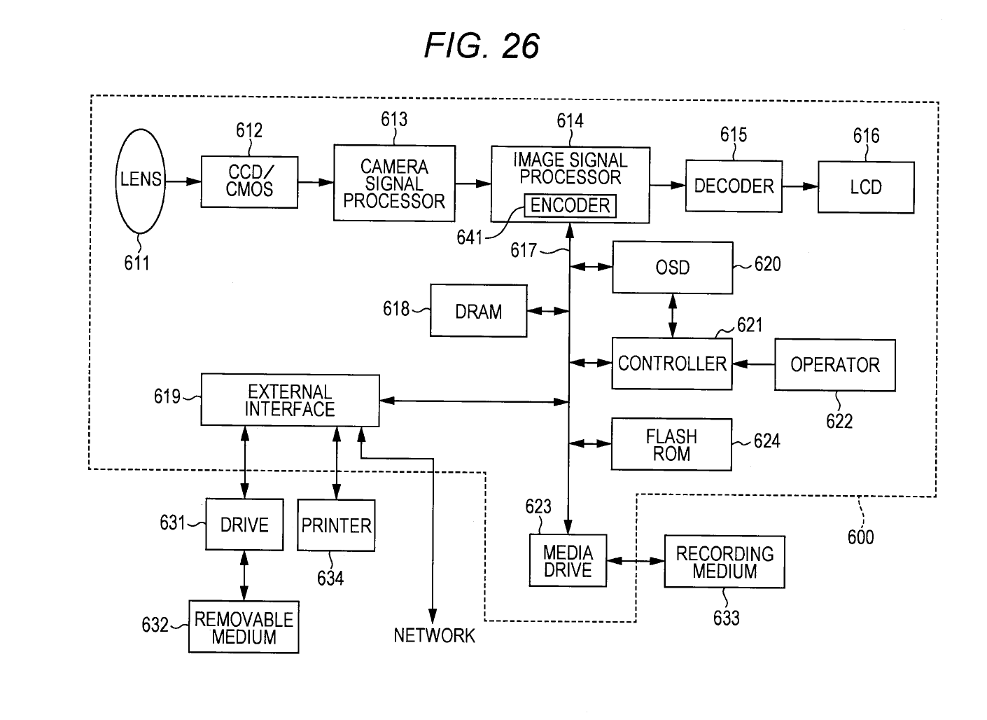

FIG. 26 is a block diagram depicting a main configuration example of a camera using an image decoding apparatus and an image coding apparatus to which the present invention is applied.

A camera 600 depicted in FIG. 26 is configured to photograph a subject, to cause the images of the subject to be displayed on an LCD 616, and to record the images on a recording medium 633 as image data.

A lens block 611 allows light (i.e., video of a subject) to be incident on a CCD/CMOS 612. The CCD/CMOS 612 is an image sensor using a CCD or a CMOS and is adapted to convert the intensity of the received light into electrical signals and to supply the signals to a camera signal processor 613.

The camera signal processor 613 converts the electrical signals supplied from the CCD/CMOS 612 to color difference signals of Y, Cr, and Cb and supplies the signals to an image signal processor 614. The image signal processor 614 performs, under the control of a controller 621, prescribed image processing on the image signals supplied from the camera signal processor 613 and encodes the image signals according to, for example, an MPEG standard by means of an encoder 641. The image signal processor 614 supplies to a decoder 615 the encoded data generated by encoding the image signals. Further, the image signal processor 614 obtains displaying data generated at an on screen display (OSD) 620 and supplies the data to the decoder 615.

In the above-described processing, the camera signal processor 613 appropriately uses a DRAM (Dynamic Random Access Memory) 618 connected through a bus 617 and causes the DRAM 618 to retain image data and the encoded data obtained by encoding the image data, and other data, as needed.

The decoder 615 decodes the encoded data supplied from the image signal processor 614 and supplies the resultant image data (decoded image data) to the LCD 616. The decoder 615 also supplies displaying data supplied from the image signal processor 614 to the LCD 616. The LCD 616 suitably synthesizes the images of the decoded data supplied from the decoder 615 with the displaying data, so as to display the synthesized data.

The on screen display 620 outputs, under the control of the controller 621, outputs displaying data for, for example, menu screens and icons containing symbols, characters, or figures, through the bus 617 to the image signal processor 614.

The controller 621 executes various kinds of processing based on the signals indicating commands that the user gives by using an operator 622 and also executes control through the bus 617 over, for example, the image signal processor 614, the DRAM 618, an external interface 619, the on screen display 620, and a media drive 623. Stored on the FLASH ROM 624 are, for example, programs and data to be used to enable the controller 621 to execute various kinds of processing.

For example, the controller 621 may, instead of the image signal processor 614 and the decoder 615, encode the image data stored on the DRAM 618 and decode the encoded data stored on the DRAM 618. In so doing, the controller 621 may perform encoding/decoding processing according to the same standard as the coding and decoding standard adopted by the image signal processor 614 and the decoder 615, or alternatively, may perform encoding/decoding processing according to a standard that is not supported by the image signal processor 614 and the decoder 615.

Further, for example, in the case where image printing is instructed by means of the operator 622, the controller 621 reads relevant image data from the DRAM 618 and supplies the data through the bus 617 to a printer 634 to be connected to the external interface 619 for printing.

Moreover, for example, in the case where image recording is instructed by means of the operator 622, the controller 621 reads relevant encoded data from the DRAM 618 and supplies the data through the bus 617 to a recording medium 633 to be loaded to the media drive 623.

The recording medium 633 is a readable and writable removable medium such as a magnetic disk, a magnetoptical disk, an optical disk, or a semiconductor memory. The recording medium 633 may obviously of any types of removable media; for example, the recording medium 633 may be a tape device, a disk, or a memory card. Apparently, a non-contact IC card may also be included in the types.

Furthermore, the media drive 623 and the recording medium 633 may be integrated, so as to be configured into a non-portable recording medium such as a built-in hard disk drive or an SSD (Solid State Drive.)

The external interface 619 may be configured, for example, by a USB Input/Output terminal and is to be connected to the printer 634 for printing images. A drive 631 is to be connected to the external interface 619 as needed, to be appropriately loaded with a removable medium 632 such as a magnetic disk, an optical disk, or a magnetoptical disk, such that computer programs read therefrom are installed on the FLASH ROM 624 as needed.

The external interface 619 further includes a network interface to be connected to a prescribed network such as a LAN or the Internet. For example, the controller 621 is configured to read, in response to an instruction from the operator 622, encoded data from the DRAM 618, so as to supply the data through the external interface 619 to another apparatus to be connected thereto via the network. The controller 621 may also obtain encoded data and image data to be supplied from another apparatus over the network through the external interface 619, so as to cause the DRAM 618 to retain the data or to supply the data to the image signal processor 614.

The above-described camera 600 uses the image decoding apparatus 101 in the form of the decoder 615. Hence, the decoder 615 achieves, as in the case of the image decoding apparatus 101, improvement in prediction accuracy for B pictures, especially in the vicinity of edges of screens, thus allowing for improvement in coding efficiency.

Hence, the camera 600 is capable of generating more precise prediction images. As a result, the camera 600 is capable of obtaining finer decoded images from, for example, image data generated at the CCD/CMOS 612, the encoded data of video data read from the DRAM 618 or the recording medium 633, and the encoded data of video data obtained over networks, for display on the LCD 616.

The camera 600 uses the image coding apparatus 51 in the form of the encoder 641. Hence, the encoder 641 achieves, as in the case of the image coding apparatus 51, improvement in prediction accuracy for B pictures, especially in the vicinity of edges of screens, thus allowing for improvement in coding efficiency.

Accordingly, the camera 600 achieves improvement in coding efficiency of encoded data to be recorded, for example, on hard disks. As a result, the camera 600 is allowed for use of recording areas in the DRAM 618 and the recording medium 633 at a higher rate and efficiency.

It is to be noted that a decoding method of the image decoding apparatus 101 is applicable to the decoding processing to be performed by the controller 621. Likewise, an encoding method of the image coding apparatus 51 is applicable to the encoding processing to be performed by the controller 621.

Further, image data to be photographed by the camera 600 may be either moving images or still images.

Apparently, the image coding apparatus 51 and the image decoding apparatus 101 are applicable to apparatuses and systems other than those described above.

### REFERENCE SIGNS LIST

51 Image coding apparatus
66 Lossless encoder
75 Motion predictor/compensator
81 Interpolation filter
82 Compensation processor
82 Selector
83 Motion vector predictor
84 Prediction mode decider
85 L0 region selector
92 L1 region selector
93 Arithmetic operator
93A, 93B Multiplier
93C Adder
94 Screen edge determiner
95 Weight calculator
101 Image decoding apparatus
112 Lossless decoder
121 Motion compensator
131 Interpolation filter
132 Compensation processor
133 Selector
134 Motion vector predictor
141 L0 region selector
142 L1 region selector
143 Arithmetic operator
143A, 143B Multiplier
143C Adder
144 Screen edge determiner

1. An image processing apparatus, comprising:
motion prediction compensating means for performing, in prediction using a plurality of different reference images to be referenced for an image to be processed, weighted prediction according to whether or not pixels to be referenced for a block in the image are off-screen in the plurality of reference images.

2. The image processing apparatus according to claim 1, wherein
the motion prediction compensating means is adapted to perform, in case where reference for the block in the image is on-screen pixels in the plurality of reference images, standardized weighted prediction by using the pixels, and
the motion prediction compensating means is adapted to perform, in case where reference for the block in the image is off-screen pixels in any one of the plurality of reference images and is on-screen pixels in the other of the reference images, the weighted prediction by using these pixels.

3. The image processing apparatus according to claim 2, wherein a larger weight is placed on the on-screen pixels than on the off-screen pixels.

4. The image processing apparatus according to claim 3, wherein a weight for use in the weighted prediction is 0 or 1.

5. The image processing apparatus according to claim 3, further comprising
weight calculating means for calculating the weight for the weighted prediction based on discontinuity between pixels in the vicinity of the block in the image.

6. The image processing apparatus according to claim 5, further comprising
encoding means for encoding information on the weight to be calculated by the weight calculating means.

7. The image processing apparatus according to claim 3, further comprising
decoding means for decoding the information on the weight to be calculated based on discontinuity between pixels in the vicinity of the block in the image and to be encoded, wherein
the motion prediction compensating means is adapted to use the information on the weight to be decoded by the decoding means for performing the weighted prediction.

8. The image processing apparatus according to claim 2, wherein the prediction using a plurality of different reference images is at least one of bi-predictive prediction or direct mode prediction.

9. A method of processing images for use in an image processing apparatus including motion prediction compensating means, the method comprising performing, in prediction using a plurality of different reference images to be referenced for an image to be processed, weighted prediction by the motion prediction compensating means according to whether or not reference for a block in the image is off-screen in the plurality of reference images.

10. A program for causing a computer to perform a function as motion prediction compensating means for performing, in prediction using a plurality of different reference images to be referenced for an image to be processed, weighted prediction according to whether or not reference for a block in the image is off-screen in the plurality of reference images.
